(19) United States
(12) Patent Application Publication
(10) Pub. No.: US 2026/0197718 A1
(43) Pub. Date: Jul. 9, 2026

(54) DEVICES, METHODS, APPARATUSES, AND COMPUTER READABLE MEDIA FOR NETWORK SLICE SECURITY

(71) Applicant: Nokia Technologies Oy, Espoo (FI)

(72) Inventors: Rajesh Babu NATARAJAN, Bangalore (IN); Jing PING, Chengdu (CN); Ranganathan MAVUREDDI DHANASEKARAN, Munich (DE)

(21) Appl. No.: 19/133,312

(22) PCT Filed: Nov. 29, 2022
(86) PCT No.: PCT/CN2022/134893

§ 371 Date: May 28, 2025

(51) Int. Cl. H04W 36/00; H04W 12/041; H04W 12/08

(52) U.S. Cl. CPC H04W 36/0038; H04W 12/041; H04W 12/08

(57) ABSTRACT

Disclosed are devices, methods, apparatuses, and computer readable media for network slice security. An example terminal device may include at least one processor and at least one memory. The at least one memory may store instructions that, when executed by the at least one processor, may cause the terminal device at least to perform: receiving from a source access network device associated with a handover of the terminal device, security information specific to a slice; and deriving at least one key specific to the slice based on the security information specific to the slice.

### TECHNICAL FIELD

Various embodiments relate to devices, methods, apparatuses, and computer readable media for network slice security.

### BACKGROUND

A network slice, which may also be briefly referred to as a slice, can be understood as a logical network on top of a shared infrastructure. For example, a variety of communication service instances with different requirements for data rate, reliability, latency, communication range and speed can be supported with multiple network slice instances co-existing on top of the same network infrastructure. Different service types may include different degrees of isolation and security requirements. Weak network slice isolation may compromise the entire network e.g. the fifth generation system (5GS) security, for example, sensitive data of one network slice could be exposed to applications running in other network slices through side channel attacks. In mobility scenarios, for example, a user equipment (UE) may hand over from one base transceiver station (BTS), e.g. an evolved node-B (eNB), a next generation node-B (gNB), etc. to another BTS, network slice isolation also needs to be addressed so as to ensure a reliable and warranted service while providing the network slice service continuity.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a terminal device. The terminal device may include at least one processor and at least one memory. The at least one memory may store instructions that, when executed by the at least one processor, may cause the terminal device at least to perform: receiving from a source access network device associated with a handover of the terminal device, security information specific to a slice; and deriving at least one key specific to the slice based on the security information specific to the slice.

In some example embodiments, the slice may be a first slice or a second slice remapped from the first slice.

In some example embodiments, the second slice may be equivalent to the first slice, the security information specific to the first slice may comprise at least one of the following: an identity of the first slice, or crypto algorithm information specific to the first slice, and the security information specific to the second slice may comprise at least one of the following: an identity of the second slice, or crypto algorithm information specific to the second slice.

In a second aspect, disclosed is a network device. The network device may include at least one processor and at least one memory. The at least one memory may store instructions that, when executed by the at least one processor, may cause the network device at least to perform: selecting a target access network device associated with a handover of a terminal device, based on a security capability, of the target access network device, specific to a first slice used by the terminal device; and transmitting to the target access network device, security information specific to the first slice or security information specific to a second slice remapped from the first slice.

In some example embodiments, the security information specific to the first slice may comprise at least one of the following: an identity of the first slice, or crypto algorithm information specific to the first slice.

In some example embodiments, the network device may be a source access network device associated with the handover, and the instructions, when executed by the at least one processor, may cause the network device to further perform: receiving from the target access network device, respective security capabilities specific to one or more slices supported by the target access network device.

In some example embodiments, the respective security capabilities specific to the one or more slices may comprise at least one of the following: respective identities of the one or more slices or respective crypto algorithm information specific to the one or more slices.

In some example embodiments, the instructions, when executed by the at least one processor, may cause the network device to further perform: receiving from the target access network device, security information specific to a second slice remapped from the first slice; and transmitting to the terminal device, the security information specific to the second slice.

In some example embodiments, the second slice may be equivalent to the first slice, and the security information specific to the second slice may comprise at least one of the following: an identity of the second slice, or crypto algorithm information specific to the second slice.

In some example embodiments, the network device may be a target core network device associated with the handover, and the instructions, when executed by the at least one processor, may cause the network device to further perform: receiving from the target access network device or another core network device, respective security capabilities specific to one or more slices supported by the target access network device.

In some example embodiments, the respective security capabilities specific to the one or more slices may comprise at least one of the following: respective identities of the one or more slices or respective crypto algorithm information specific to the one or more slices.

In some example embodiments, the instructions, when executed by the at least one processor, may cause the network device to further perform: receiving from a source core network device associated with the handover, the security information specific to the first slice.

In some example embodiments, the instructions, when executed by the at least one processor, may cause the network device to further perform: determining the second slice remapped from the first slice in a case where the first slice is unsupported by the target access network device; and transmitting to the target access network device, an indication indicating that the second slice is remapped from the first slice.

In some example embodiments, the instructions, when executed by the at least one processor, may cause the network device to further perform: receiving from the target access network device, security information specific to a second slice remapped from the first slice; and transmitting to the source core network device, the security information specific to the second slice.

In some example embodiments, the instructions, when executed by the at least one processor, may cause the network device to further perform: determining the security information specific to the second slice remapped from the first slice in a case where the first slice is unsupported by the target access network device; and transmitting to the source core network device, the security information specific to the second slice, and the security information specific to the second slice may be transmitted to the target access network device.

In some example embodiments, the second slice may be equivalent to the first slice, and the security information specific to the second slice may comprise at least one of the following: an identity of the second slice, or crypto algorithm information specific to the second slice.

In a third aspect, disclosed is an access network device. The access network device may include at least one processor and at least one memory. The at least one memory may store instructions that, when executed by the at least one processor, may cause the access network device as a target access network device associated with a handover of a terminal device at least to perform: receiving from another network device associated with the handover of the terminal device, security information specific to a first slice used by the terminal device or security information specific to a second slice remapped from the first slice.

In some example embodiments, the security information specific to the first slice may comprise at least one of the following: an identity of the first slice, or crypto algorithm information specific to the first slice.

In some example embodiments, the instructions, when executed by the at least one processor, may cause the access network device to further perform: determining security information specific to a second slice remapped from the first slice in a case where the first slice is unsupported by the target access network device, the second slice may be equivalent to the first slice, and the security information specific to the second slice may comprise at least one of the following: an identity of the second slice, or crypto algorithm information specific to the second slice.

In some example embodiments, the instructions, when executed by the at least one processor, may cause the access network device to further perform: transmitting to the another network device, the security information specific to the second slice; and deriving at least one key specific to the second slice based on the security information specific to the second slice. In some example embodiments, the instructions, when executed by the at least one processor, may cause the access network device to further perform: determining a second slice remapped from the first slice in a case where the first slice is unsupported by the target access network device; and deriving at least one key specific to the first slice based on the security information specific to the first slice.

In some example embodiments, the another network device may be a target core network device associated with the handover of the terminal device, and the instructions, when executed by the at least one processor, may cause the access network device to further perform: receiving from the target core network device, the security information specific to the second slice remapped from the first slice in a case where the first slice is unsupported by the target access network device; and deriving at least one key specific to the second slice based on the security information specific to the second slice, the second slice may be equivalent to the first slice, and the security information specific to the second slice may comprise at least one of the following: an identity of the second slice, or crypto algorithm information specific to the second slice.

In some example embodiments, the another network device may be a target core network device associated with the handover of the terminal device, and the instructions, when executed by the at least one processor, may cause the access network device to further perform: receiving from the target core network device, an indication indicating that a second slice is remapped from the first slice; and deriving at least one key specific to the first slice based on the security information specific to the first slice.

In some example embodiments, the another network device may be a target core network device associated with the handover of the terminal device, and the instructions, when executed by the at least one processor, may cause the access network device to further perform: deriving at least one key specific to the second slice based on the security information specific to the second slice in case of receiving from target core network device the security information specific to the second slice, and the second slice may be equivalent to the first slice, and the security information specific to the second slice may comprise at least one of the following: an identity of the second slice, or crypto algorithm information specific to the second slice.

In some example embodiments, the another network device may be a source access network device associated with the handover of the terminal device, and the instructions, when executed by the at least one processor, may cause the access network device to further perform: transmitting to the source access network device, respective security capabilities specific to one or more slices supported by the target access network device.

In some example embodiments, the another network device may be a target core network device associated with the handover of the terminal device, and the instructions, when executed by the at least one processor, may cause the access network device to further perform: transmitting to the target core network device or another core network device, respective security capabilities specific to one or more slices supported by the target access network device.

In some example embodiments, the respective security capabilities specific to the one or more slices may comprise at least one of the following: respective identities of the one or more slices or respective crypto algorithm information specific to the one or more slices.

In a fourth aspect, disclosed is a method performed by a terminal device. The method may comprise: receiving from a source access network device associated with a handover of the terminal device, security information specific to a slice; and deriving at least one key specific to the slice based on the security information specific to the slice.

In some example embodiments, the slice may be a first slice or a second slice remapped from the first slice.

In some example embodiments, the second slice may be equivalent to the first slice, the security information specific to the first slice may comprise at least one of the following: an identity of the first slice, or crypto algorithm information specific to the first slice, and the security information specific to the second slice may comprise at least one of the following: an identity of the second slice, or crypto algorithm information specific to the second slice.

In a fifth aspect, disclosed is a method performed by a network device. The method may comprise: selecting a target access network device associated with a handover of a terminal device, based on a security capability, of the target access network device, specific to a first slice used by the terminal device; and transmitting to the target access network device, security information specific to the first slice or security information specific to a second slice remapped from the first slice.

In some example embodiments, the security information specific to the first slice may comprise at least one of the following: an identity of the first slice, or crypto algorithm information specific to the first slice.

In some example embodiments, the network device may be a source access network device associated with the handover, and the method may further comprise: receiving from the target access network device, respective security capabilities specific to one or more slices supported by the target access network device.

In some example embodiments, the respective security capabilities specific to the one or more slices may comprise at least one of the following: respective identities of the one or more slices or respective crypto algorithm information specific to the one or more slices.

In some example embodiments, the method may further comprise: receiving from the target access network device, security information specific to a second slice remapped from the first slice; and transmitting to the terminal device, the security information specific to the second slice.

In some example embodiments, the second slice may be equivalent to the first slice, and the security information specific to the second slice may comprise at least one of the following: an identity of the second slice, or crypto algorithm information specific to the second slice.

In some example embodiments, the network device may be a target core network device associated with the handover, and the method may further comprise: receiving from the target access network device or another core network device, respective security capabilities specific to one or more slices supported by the target access network device.

In some example embodiments, the respective security capabilities specific to the one or more slices may comprise at least one of the following: respective identities of the one or more slices or respective crypto algorithm information specific to the one or more slices.

In some example embodiments, the method may further comprise: receiving from a source core network device associated with the handover, the security information specific to the first slice.

In some example embodiments, the method may further comprise: determining a second slice remapped from the first slice in a case where the first slice is unsupported by the target access network device; and transmitting to the target access network device, an indication indicating that the second slice is remapped from the first slice.

In some example embodiments, the method may further comprise: receiving from the target access network device, security information specific to a second slice remapped from the first slice; and transmitting to the source core network device, the security information specific to the second slice.

In some example embodiments, the method may further comprise: determining the security information specific to the second slice remapped from the first slice in a case where the first slice is unsupported by the target access network device; and transmitting to the source core network device, the security information specific to the second slice, and the security information specific to the second slice may be transmitted to the target access network device.

In some example embodiments, the second slice may be equivalent to the first slice, and the security information specific to the second slice may comprise at least one of the following: an identity of the second slice, or crypto algorithm information specific to the second slice.

In a sixth aspect, disclosed is a method performed by an access network device as a target access network device associated with a handover of a terminal device. The method may comprise: receiving from another network device associated with the handover of the terminal device, security information specific to a first slice used by the terminal device or security information specific to a second slice remapped from the first slice.

In some example embodiments, the security information specific to the first slice may comprise at least one of the following: an identity of the first slice, or crypto algorithm information specific to the first slice.

In some example embodiments, the method may further comprise: determining security information specific to a second slice remapped from the first slice in a case where the first slice is unsupported by the target access network device, the second slice may be equivalent to the first slice, and the security information specific to the second slice may comprise at least one of the following: an identity of the second slice, or crypto algorithm information specific to the second slice.

In some example embodiments, the method may further comprise: transmitting to the another network device, the security information specific to the second slice; and deriving at least one key specific to the second slice based on the security information specific to the second slice.

In some example embodiments, the method may further comprise: determining a second slice remapped from the first slice in a case where the first slice is unsupported by the target access network device; and deriving at least one key specific to the first slice based on the security information specific to the first slice.

In some example embodiments, the another network device may be a target core network device associated with the handover of the terminal device, and the method may further comprise: receiving from the target core network device, the security information specific to the second slice remapped from the first slice in a case where the first slice is unsupported by the target access network device; and deriving at least one key specific to the second slice based on the security information specific to the second slice, the second slice may be equivalent to the first slice, and the security information specific to the second slice may comprise at least one of the following: an identity of the second slice, or crypto algorithm information specific to the second slice.

In some example embodiments, the another network device may be a target core network device associated with the handover of the terminal device, and the method may further comprise: receiving from the target core network device, an indication indicating that a second slice is remapped from the first slice; and deriving at least one key specific to the first slice based on the security information specific to the first slice.

In some example embodiments, the another network device may be a target core network device associated with the handover of the terminal device, and the method may further comprise: deriving at least one key specific to the second slice based on the security information specific to the second slice in case of receiving from target core network device the security information specific to the second slice, and the second slice may be equivalent to the first slice, and the security information specific to the second slice may comprise at least one of the following: an identity of the second slice, or crypto algorithm information specific to the second slice.

In some example embodiments, the another network device may be a source access network device associated with the handover of the terminal device, and the method may further comprise: transmitting to the source access network device, respective security capabilities specific to one or more slices supported by the target access network device.

In some example embodiments, the another network device may be a target core network device associated with the handover of the terminal device, and the method may further comprise: transmitting to the target core network device or another core network device, respective security capabilities specific to one or more slices supported by the target access network device.

In some example embodiments, the respective security capabilities specific to the one or more slices may comprise at least one of the following: respective identities of the one or more slices or respective crypto algorithm information specific to the one or more slices.

In a seventh aspect, disclosed is an apparatus. The apparatus as a terminal device may comprise: means for receiving from a source access network device associated with a handover of the terminal device, security information specific to a slice; and means for deriving at least one key specific to the slice based on the security information specific to the slice.

In some example embodiments, the slice may be a first slice or a second slice remapped from the first slice.

In some example embodiments, the second slice may be equivalent to the first slice, the security information specific to the first slice may comprise at least one of the following: an identity of the first slice, or crypto algorithm information specific to the first slice, and the security information specific to the second slice may comprise at least one of the following: an identity of the second slice, or crypto algorithm information specific to the second slice.

In an eighth aspect, disclosed is an apparatus. The apparatus as a network device may comprise: means for selecting a target access network device associated with a handover of a terminal device, based on a security capability, of the target access network device, specific to a first slice used by the terminal device; and means for transmitting to the target access network device, security information specific to the first slice or security information specific to a second slice remapped from the first slice.

In some example embodiments, the security information specific to the first slice may comprise at least one of the following: an identity of the first slice, or crypto algorithm information specific to the first slice.

In some example embodiments, the network device may be a source access network device associated with the handover, and the apparatus may further comprise: means for receiving from the target access network device, respective security capabilities specific to one or more slices supported by the target access network device.

In some example embodiments, the respective security capabilities specific to the one or more slices may comprise at least one of the following: respective identities of the one or more slices or respective crypto algorithm information specific to the one or more slices.

In some example embodiments, the apparatus may further comprise: means for receiving from the target access network device, security information specific to a second slice remapped from the first slice; and means for transmitting to the terminal device, the security information specific to the second slice.

In some example embodiments, the second slice may be equivalent to the first slice, and the security information specific to the second slice may comprise at least one of the following: an identity of the second slice, or crypto algorithm information specific to the second slice.

In some example embodiments, the network device may be a target core network device associated with the handover, and the apparatus may further comprise: means for receiving from the target access network device or another core network device, respective security capabilities specific to one or more slices supported by the target access network device.

In some example embodiments, the respective security capabilities specific to the one or more slices may comprise at least one of the following: respective identities of the one or more slices or respective crypto algorithm information specific to the one or more slices.

In some example embodiments, the apparatus may further comprise: means for receiving from a source core network device associated with the handover, the security information specific to the first slice.

In some example embodiments, the apparatus may further comprise: means for determining a second slice remapped from the first slice in a case where the first slice is unsupported by the target access network device; and means for transmitting to the target access network device, an indication indicating that the second slice is remapped from the first slice.

In some example embodiments, the apparatus may further comprise: means for receiving from the target access network device, security information specific to a second slice remapped from the first slice; and means for transmitting to the source core network device, the security information specific to the second slice.

In some example embodiments, the apparatus may further comprise: means for determining the security information specific to the second slice remapped from the first slice in a case where the first slice is unsupported by the target access network device; and means for transmitting to the source core network device, the security information specific to the second slice, and the security information specific to the second slice may be transmitted to the target access network device.

In some example embodiments, the second slice may be equivalent to the first slice, and the security information specific to the second slice may comprise at least one of the following: an identity of the second slice, or crypto algorithm information specific to the second slice.

In a ninth aspect, disclosed is an apparatus. The apparatus as an access network device as a target access network device associated with a handover of a terminal device may comprise: means for receiving from another network device associated with the handover of the terminal device, security information specific to a first slice used by the terminal device or security information specific to a second slice remapped from the first slice.

In some example embodiments, the security information specific to the first slice may comprise at least one of the following: an identity of the first slice, or crypto algorithm information specific to the first slice.

In some example embodiments, the apparatus may further comprise: means for determining security information specific to a second slice remapped from the first slice in a case where the first slice is unsupported by the target access network device, the second slice may be equivalent to the first slice, and the security information specific to the second slice may comprise at least one of the following: an identity of the second slice, or crypto algorithm information specific to the second slice.

In some example embodiments, the apparatus may further comprise: means for transmitting to the another network device, the security information specific to the second slice; and means for deriving at least one key specific to the second slice based on the security information specific to the second slice.

In some example embodiments, the apparatus may further comprise: means for determining a second slice remapped from the first slice in a case where the first slice is unsupported by the target access network device; and means for deriving at least one key specific to the first slice based on the security information specific to the first slice.

In some example embodiments, the another network device may be a target core network device associated with the handover of the terminal device, and the apparatus may further comprise: means for receiving from the target core network device, the security information specific to the second slice remapped from the first slice in a case where the first slice is unsupported by the target access network device; and means for deriving at least one key specific to the second slice based on the security information specific to the second slice, the second slice may be equivalent to the first slice, and the security information specific to the second slice may comprise at least one of the following: an identity of the second slice, or crypto algorithm information specific to the second slice.

In some example embodiments, the another network device may be a target core network device associated with the handover of the terminal device, and the apparatus may further comprise: means for receiving from the target core network device, an indication indicating that a second slice is remapped from the first slice; and means for deriving at least one key specific to the first slice based on the security information specific to the first slice.

In some example embodiments, the another network device may be a target core network device associated with the handover of the terminal device, and the apparatus may further comprise: means for deriving at least one key specific to the second slice based on the security information specific to the second slice in case of receiving from target core network device the security information specific to the second slice, and the second slice may be equivalent to the first slice, and the security information specific to the second slice may comprise at least one of the following: an identity of the second slice, or crypto algorithm information specific to the second slice.

In some example embodiments, the another network device may be a source access network device associated with the handover of the terminal device, and the apparatus may further comprise: means for transmitting to the source access network device, respective security capabilities specific to one or more slices supported by the target access network device.

In some example embodiments, the another network device may be a target core network device associated with the handover of the terminal device, and the apparatus may further comprise: means for transmitting to the target core network device or another core network device, respective security capabilities specific to one or more slices supported by the target access network device.

In some example embodiments, the respective security capabilities specific to the one or more slices may comprise at least one of the following: respective identities of the one or more slices or respective crypto algorithm information specific to the one or more slices.

In a tenth aspect, a computer readable medium is disclosed. The computer readable medium may comprise program instructions that, when executed by a terminal device, cause the terminal device at least to perform: receiving from a source access network device associated with a handover of the terminal device, security information specific to a slice; and deriving at least one key specific to the slice based on the security information specific to the slice.

In some example embodiments, the slice may be a first slice or a second slice remapped from the first slice.

In some example embodiments, the second slice may be equivalent to the first slice, the security information specific to the first slice may comprise at least one of the following: an identity of the first slice, or crypto algorithm information specific to the first slice, and the security information specific to the second slice may comprise at least one of the following: an identity of the second slice, or crypto algorithm information specific to the second slice.

In an eleventh aspect, a computer readable medium is disclosed. The computer readable medium may comprise program instructions that, when executed by a network device, cause the network device at least to perform: selecting a target access network device associated with a handover of a terminal device, based on a security capability, of the target access network device, specific to a first slice used by the terminal device; and transmitting to the target access network device, security information specific to the first slice or security information specific to a second slice remapped from the first slice.

In some example embodiments, the security information specific to the first slice may comprise at least one of the following: an identity of the first slice, or crypto algorithm information specific to the first slice.

In some example embodiments, the network device may be a source access network device associated with the handover, and the computer readable medium may further comprise instructions that, when executed by the network device, may cause the network device to further perform: receiving from the target access network device, respective security capabilities specific to one or more slices supported by the target access network device.

In some example embodiments, the respective security capabilities specific to the one or more slices may comprise at least one of the following: respective identities of the one or more slices or respective crypto algorithm information specific to the one or more slices.

In some example embodiments, the computer readable medium may further comprise instructions that, when executed by the network device, may cause the network device to further perform: receiving from the target access network device, security information specific to a second slice remapped from the first slice; and transmitting to the terminal device, the security information specific to the second slice.

In some example embodiments, the second slice may be equivalent to the first slice, and the security information specific to the second slice may comprise at least one of the following: an identity of the second slice, or crypto algorithm information specific to the second slice.

In some example embodiments, the network device may be a target core network device associated with the handover, and the computer readable medium may further comprise instructions that, when executed by the network device, may cause the network device to further perform: receiving from the target access network device or another core network device, respective security capabilities specific to one or more slices supported by the target access network device.

In some example embodiments, the respective security capabilities specific to the one or more slices may comprise at least one of the following: respective identities of the one or more slices or respective crypto algorithm information specific to the one or more slices.

In some example embodiments, the computer readable medium may further comprise instructions that, when executed by the network device, may cause the network device to further perform: receiving from a source core network device associated with the handover, the security information specific to the first slice.

In some example embodiments, the computer readable medium may further comprise instructions that, when executed by the network device, may cause the network device to further perform: determining a second slice remapped from the first slice in a case where the first slice is unsupported by the target access network device; and transmitting to the target access network device, an indication indicating that the second slice is remapped from the first slice.

In some example embodiments, the computer readable medium may further comprise instructions that, when executed by the network device, may cause the network device to further perform: receiving from the target access network device, security information specific to a second slice remapped from the first slice; and transmitting to the source core network device, the security information specific to the second slice.

In some example embodiments, the computer readable medium may further comprise instructions that, when executed by the network device, may cause the network device to further perform: determining the security information specific to the second slice remapped from the first slice in a case where the first slice is unsupported by the target access network device; and transmitting to the source core network device, the security information specific to the second slice, and the security information specific to the second slice may be transmitted to the target access network device.

In some example embodiments, the second slice may be equivalent to the first slice, and the security information specific to the second slice may comprise at least one of the following: an identity of the second slice, or crypto algorithm information specific to the second slice.

In a twelfth aspect, a computer readable medium is disclosed. The computer readable medium may comprise program instructions that, when executed by an access network device as a target access network device associated with a handover of a terminal device, cause the access network device at least to perform: receiving from another network device associated with the handover of the terminal device, security information specific to a first slice used by the terminal device or security information specific to a second slice remapped from the first slice.

In some example embodiments, the security information specific to the first slice may comprise at least one of the following: an identity of the first slice, or crypto algorithm information specific to the first slice.

In some example embodiments, the computer readable medium may further comprise instructions that, when executed by the access network device, may cause the access network device to further perform: determining security information specific to a second slice remapped from the first slice in a case where the first slice is unsupported by the target access network device, the second slice may be equivalent to the first slice, and the security information specific to the second slice may comprise at least one of the following: an identity of the second slice, or crypto algorithm information specific to the second slice.

In some example embodiments, the computer readable medium may further comprise instructions that, when executed by the access network device, may cause the access network device to further perform: transmitting to the another network device, the security information specific to the second slice; and deriving at least one key specific to the second slice based on the security information specific to the second slice.

In some example embodiments, the computer readable medium may further comprise instructions that, when executed by the access network device, may cause the access network device to further perform: determining a second slice remapped from the first slice in a case where the first slice is unsupported by the target access network device; and deriving at least one key specific to the first slice based on the security information specific to the first slice.

In some example embodiments, the another network device may be a target core network device associated with the handover of the terminal device, and the computer readable medium may further comprise instructions that, when executed by the access network device, may cause the access network device to further perform: receiving from the target core network device, the security information specific to the second slice remapped from the first slice in a case where the first slice is unsupported by the target access network device; and deriving at least one key specific to the second slice based on the security information specific to the second slice, the second slice may be equivalent to the first slice, and the security information specific to the second slice may comprise at least one of the following: an identity of the second slice, or crypto algorithm information specific to the second slice.

In some example embodiments, the another network device may be a target core network device associated with the handover of the terminal device, and the computer readable medium may further comprise instructions that, when executed by the access network device, may cause the access network device to further perform: receiving from the target core network device, an indication indicating that a second slice is remapped from the first slice; and deriving at least one key specific to the first slice based on the security information specific to the first slice.

In some example embodiments, the another network device is a target core network device associated with the handover of the terminal device, and the computer readable medium may further comprise instructions that, when executed by the access network device, may cause the access network device to further perform: deriving at least one key specific to the second slice based on the security information specific to the second slice in case of receiving from target core network device the security information specific to the second slice, the second slice may be equivalent to the first slice, and the security information specific to the second slice may comprise at least one of the following: an identity of the second slice, or crypto algorithm information specific to the second slice.

In some example embodiments, the another network device may be a source access network device associated with the handover of the terminal device, and the computer readable medium may further comprise instructions that, when executed by the access network device, may cause the access network device to further perform: transmitting to the source access network device, respective security capabilities specific to one or more slices supported by the target access network device.

In some example embodiments, the another network device may be a target core network device associated with the handover of the terminal device, and the computer readable medium may further comprise instructions that, when executed by the access network device, may cause the access network device to further perform: transmitting to the target core network device or another core network device, respective security capabilities specific to one or more slices supported by the target access network device.

In some example embodiments, the respective security capabilities specific to the one or more slices may comprise at least one of the following: respective identities of the one or more slices or respective crypto algorithm information specific to the one or more slices.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence diagram for exchange of slice specific security capability during Xn setup according to example embodiments of the present disclosure.

FIG. 2 shows an exemplary sequence diagram for slice specific key update during Xn based handover procedure according to example embodiments of the present disclosure.

FIG. 3 shows an exemplary sequence diagram for slice specific key update during Xn based handover procedure according to example embodiments of the present disclosure.

FIG. 4 shows an exemplary sequence diagram for slice specific key update during Xn based handover procedure according to example embodiments of the present disclosure.

FIG. 5 shows an exemplary sequence diagram for exchange of slice specific security capability during NG setup according to an example embodiment of the present disclosure.

FIG. 6 shows an exemplary sequence diagram for slice specific key update during N2 based handover procedure according to example embodiments of the present disclosure.

FIG. 7 shows an exemplary sequence diagram for slice specific key update during N2 based handover procedure according to example embodiments of the present disclosure.

FIG. 8 shows an exemplary sequence diagram for slice specific key update during N2 based handover procedure according to example embodiments of the present disclosure.

FIG. 9 shows an exemplary sequence diagram for slice specific key update during N2 based handover procedure according to example embodiments of the present disclosure.

FIG. 10 shows an exemplary sequence diagram for slice specific key update during N2 based handover procedure according to example embodiments of the present disclosure.

FIG. 11 shows a flow chart illustrating an example method 1100 for network slice security according to the example embodiments of the present disclosure.

FIG. 12 shows a flow chart illustrating an example method 1200 for network slice security according to the example embodiments of the present disclosure.

FIG. 13 shows a flow chart illustrating an example method 1300 for network slice security according to the example embodiments of the present disclosure.

FIG. 14 shows a block diagram illustrating an example device 1400 for network slice security according to the example embodiments of the present disclosure.

FIG. 15 shows a block diagram illustrating an example device 1500 for network slice security according to the example embodiments of the present disclosure.

FIG. 16 shows a block diagram illustrating an example device 1600 for network slice security according to the example embodiments of the present disclosure.

FIG. 17 shows a block diagram illustrating an example apparatus 1700 for network slice security according to the example embodiments of the present disclosure.

FIG. 18 shows a block diagram illustrating an example apparatus 1800 for network slice security according to the example embodiments of the present disclosure.

FIG. 19 shows a block diagram illustrating an example apparatus 1900 for network slice security according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a solution on network slice security. According to the example embodiments of the present disclosure, a slice specific key sharing for mobility and service continuity may be solved. The example embodiments of the present disclosure may apply in mobility scenarios such as Xn based handover (HO) where Xn may be an interface between the BTSs in a radio access network (RAN) and/or N2 based handover where N2 may be an interface between a BTS and a function in a core network (CN) such as an access and mobility management function (AMF). Further, in a case where a target BTS associated with the handover cannot support the slice used by the UE, the service continuity may still be realized according to the example embodiments of the present disclosure.

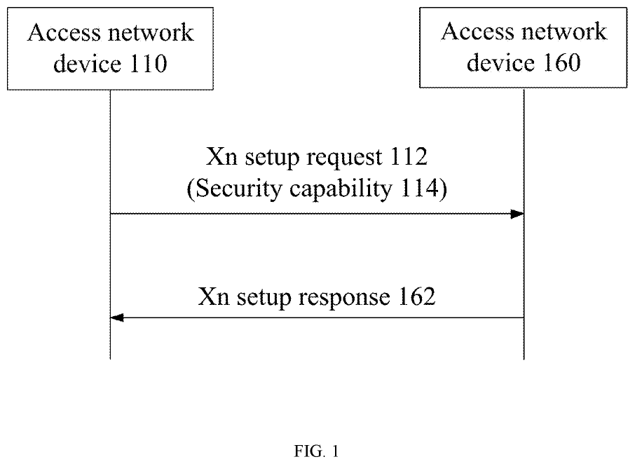

FIG. 1 shows an exemplary sequence diagram for exchange of slice specific security capability during Xn setup according to example embodiments of the present disclosure. Referring to the FIG. 1, an access network device 110 and an access network device 160 may function as a BTS, e.g. an eNB and/or a gNB in a wireless communication network. In an example, a BTS (e.g. the access network device 110) may perform an Xn setup procedure to setup an Xn interface with another BTS (e.g. the access network device 160) so as to facilitate potential handover of a UE between the two BTSs. Alternatively or additionally, the access network device 110 and/or the access network device 160 may function as a centralized unit (CU) of a BTS.

In the Xn setup procedure, the access network device 110 may transmit an Xn setup request message 112 to the access network device 160. The Xn setup request message 112 may include respective security capabilities 114 specific to one or more slices supported by the access network device 110. The respective security capabilities 114 may comprise at least one of the following: respective identities of the one or more slices supported by the access network device 110, or respective crypto algorithm specific to the one or more slices. For example, the identity of a slice may be a single network slice selection assistance information (S-NSSAI) value, and the crypto algorithm specific to a slice may relate to at least one of the following: an algorithm for user plane (UP) integrity specific to the slice, or an algorithm for UP encryption specific to the slice. The respective security capabilities 114 may be in a form of a list of the S-NSSAI and corresponding crypto algorithm.

Then, the access network device 160 may transmit to the access network device 110 an Xn setup response message 162 in response to the Xn setup request message 112.

It may be appreciated that in the wireless communication network a plurality of access network devices may transmit to the access network device 160 respective security capabilities specific to one or more slices supported by the plurality of access network devices, respectively. The security capabilities of the respective plurality of access network devices may be used by the access network device 160 to select an appropriate target access network device for a potential handover of a UE. Here, the access network device 110 may represent any of the plurality of access network devices.

Through the Xn setup procedure, the access network device 160 may obtain the information on the security capabilities of the respective plurality of access network devices. It may be appreciated that the access network device 110 may transmit the respective security capabilities 114 specific to one or more slices supported by the access network device 110 via other message not limited to the Xn setup request message 112 during the Xn setup procedure.

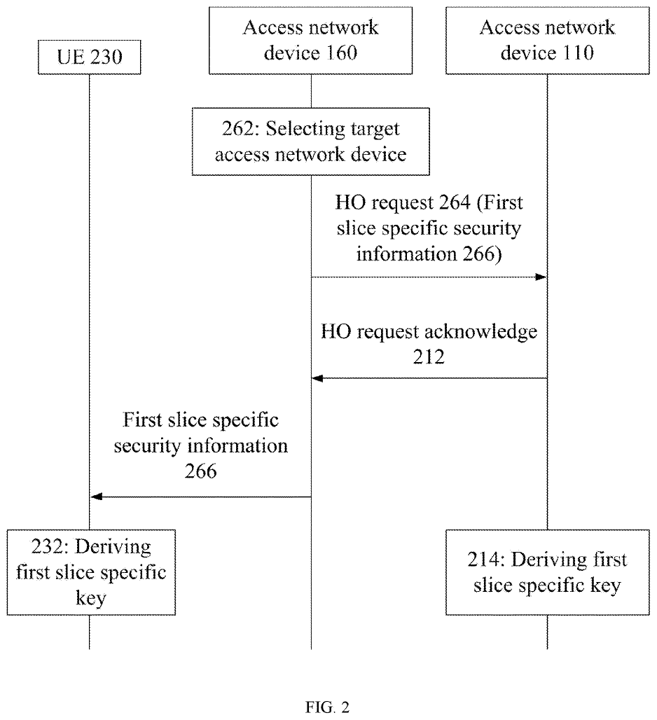

FIG. 2 shows an exemplary sequence diagram for slice specific key update during Xn based handover procedure according to example embodiments of the present disclosure. Referring to the FIG. 2, a UE 230 may represent any terminal device in the wireless communication network, which will perform a handover from the access network device 160. Before the handover procedure, it is assumed the UE 230 is in connection with the access network device 160, and thus the access network device 160 may be a source access network device for the handover. In addition, slice specific crypto algorithm may be negotiated between the UE 230 and a core network device, e.g., an AMF in the core network (not shown) of the wireless communication network during a registration procedure.

In an operation 262, the source access network device 160 may decide to handover the UE 230 to a target access network device. Assuming that the UE 230 is currently using one or more slices, a first slice may represent any of the one or more slices. The first slice is taken as an example in the descriptions, and it may be appreciated that the example embodiments of the present disclosure may apply in any of the one or more slices. In the operation 262, the source access network device 160 may select the target access network device based on security capability of the target access network device specific to a first slice used by the UE 230, which may be exchanged e.g. during the Xn setup as discussed above with reference to FIG. 1. Assuming that among the plurality of access network devices, the access network device 110 is selected as the target access network device for the handover according to e.g. the security capability, of the access network device 110, specific to the first slice. In an example, the selection may be made together with other information, such as measurement report and radio resource management (RRM) information.

Then, the source access network device 160 may transmit a handover request message 264 to the target access network device 110 with necessary information to prepare the handover at the target side. For example, the handover request 264 may comprise security information 266 specific to the first slice used by the UE 230. In an embodiment, the security information 266 specific to the first slice may comprise e.g. at least one of the following: an identity of the first slice, or crypto algorithm information specific to the first slice.

In an embodiment, the identity of the first slice may be the S-NSSAI value of the first slice. The crypto algorithm information specific to the first slice may be determined by the source access network device 160 based on the security capability of the target access network device 110 so that the target access network device 110 may support the same or similar crypto algorithm for the first slice. The crypto algorithm information specific to the first slice may for example relate to at least one of the following: an algorithm for UP integrity specific to the first slice, or an algorithm for UP encryption specific to the first slice.

In response to the handover request 264, the target access network device 110 may perform an admission control to determine whether it can serve the UE 230. When the handvoer request 264 is admitted, the target access network device 110 may transmit a handover request acknowledge 212 to the source access network device 160. The acknowledge 212 may include necessary information required for the UE 230 to perform the handover.

When the handover procedure is executed, the source access network device 160 may transmit to the UE 230 the security information 266 specific to the first slice, for the UE 230 to derive key(s) specific to the first slice. In an embodiment, the security information 266 may be included in a radio resource control (RRC) reconfiguration message, together with other information required for the UE 230 to access the target access network device 110.

Based on the security information 226 specific to the first slice received form the source access network device 160, the access network deice 110 and the UE 230 may derive the at least one security key specific to the first slice. For example, in an operation 214, the target access network device 110 may derive the security key by inputting the identity of the first slice (e.g. S-NSSAI) and/or the crypto algorithm specific to the first slice into a key derivation function (KDF). In an example, the crypto algorithm specific to the first slice may include one or more encryption and integrity algorithms for protection of UP data, respectively. One or more security keys specific to the first slice may be derived accordingly. On the UE side, in an operation 232, the UE 230 may derive at least one security key specific to the first slice in a similar manner. For example, the UE 230 may derive at least one security key specific to the first slice by inputting the security information 226 specific to the first slice into a KDF. With the derived security key(s) specific to the first slice, the UE 230 and the access network device 110 may protect uplink and downlink data.

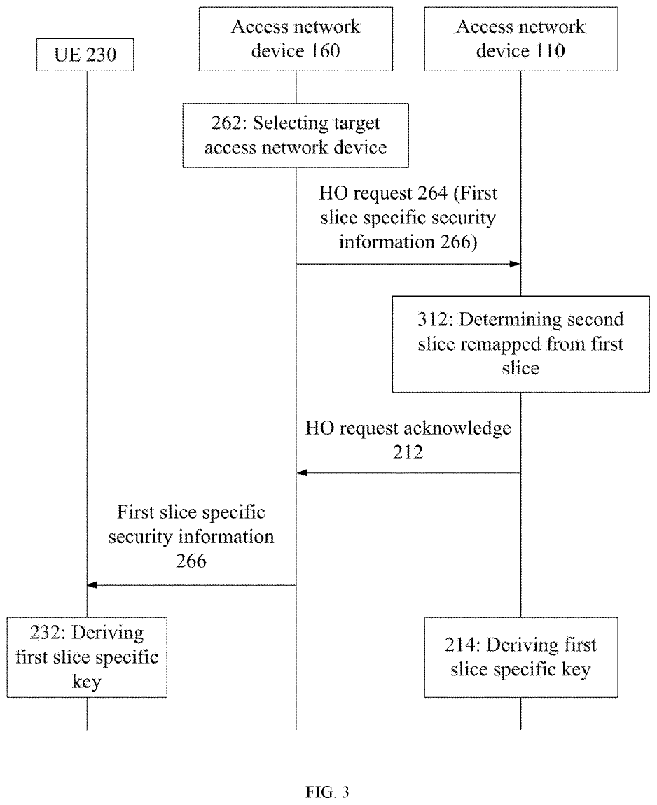

FIG. 3 shows an exemplary sequence diagram for slice specific key update during the Xn based handover procedure according to example embodiments of the present disclosure. The process shown in FIG. 3 may be performed by for example the UE 230, the access network device 160, and the access network device 110. Details which have been described with respect to the previous figure(s) are briefly described or omitted.

Referring to the FIG. 3, the source access network device 160 may in the operation 262, select the target access network device 110 based on the security capability of the target access network device 110 specific to a first slice used by the UE 230. Then, the source access network device 160 may transmit, to the selected target access network device 110, the security information 266 specific to the first slice via e.g. the handover request 264.

In response to the handover request 264, the target access network device 110 may perform the admission control to determine whether it can serve the first slice used by the UE 230. In a case where the first slice is unsupported by the target access network device 110, for example, if the target access network device 110 cannot support the first slice or the first slice is overloaded in the target access network device 110, in an operation 312, instead of rejecting the handover request, the target access network device 110 may determine a second slice remapped from the first slice, so as to provide service continuity for the UE 230. The second slice may be equivalent to the first slice. For example, the second slice and the first slice may have the same or similar security level. By way of example, if a slice S-NSSAI #1 used by the UE 230 is not supported at the target access network device 110, the target access network device 110 may determine to use a second slice S-NSSAI #2 that is also supported by the source access network device 160 and the UE 230 so that temporary slice service continuity for the UE 230 may be achieved.

Since the target access network device 110 may provide the temporary service for the UE 230 by using the remapped second slice, the target access network device 110 may transmit to the access network device 160 a handover request acknowledge 212 to indicate that the handover request is accepted, with necessary information required for the UE 230 to perform the handover.

As an option, the network side may choose to perform the slice remapping without the awareness of the UE 230. For example, the target access network device 110 may decide not to make the UE 230 be aware that the first slice has been remapped to the second slice. This decision may be made considering capability of the UE 230, policy, etc. In this case, the handover request acknowledge 212 may be e.g. without the information on the remapping.

In this case, when the handover procedure is executed, the source access network device 160 may transmit to the UE 230 the security information 266 specific to the first slice, for the UE 230 to derive key(s) specific to the first slice. For example, in the operation 232, the UE 230 may use the security information 266 specific to the first slice as inputs to a KDF to derive first slice specific security key(s). For example, the UE 230 may derive at least one security key specific to the first slice by inputting the identity of the first slice (e.g. S-NSSAI) and/or the crypto algorithm specific to the first slice into a KDF. Since the UE 230 is not aware of the slice remapping at the access network device 110, for the sake of slice specific security, the target access network device 110 may, in the operation 214, continue to use the security information 266 specific to the first slice as inputs to the KDF to derive first slice specific security key(s).

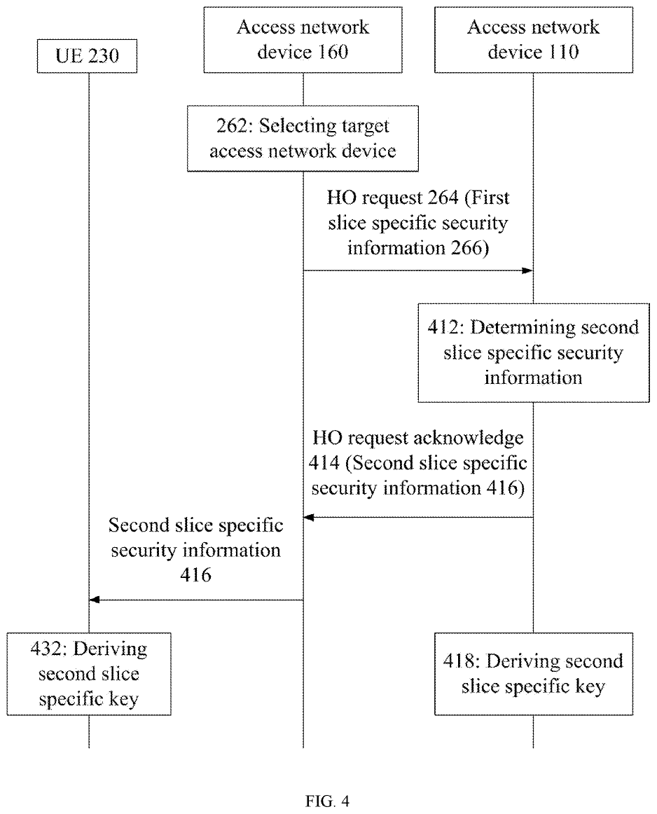

FIG. 4 shows an exemplary sequence diagram for slice specific key update during the Xn based handover procedure according to an example of the present disclosure. The process shown in FIG. 4 may be performed by for example the UE 230, the access network device 160, and the access network device 110. Details which have been described with respect to the previous figure(s) are briefly described or omitted.

Referring to FIG. 4, the source access network device 160 may in the operation 262, select the target access network device 110 based on the security capability of the target access network device 110 specific to the first slice used by the UE 230. Then, the source source access network device 160 may transmit, to the selected target access network device 110, the security information 266 specific to the first slice via e.g. the handover request 264.

In response to the handover request 264, the target access network device 110 may perform the admission control to determine whether it can serve the UE 230. In a case where the first slice is unsupported by the target access network device 110, in an operation 412, the access network device 110 may determine security information 416 specific to the second slice remapped from the first slice, so as to provide service continuity for the UE 230. The second slice may be equivalent to the first slice, and the security information 416 specific to the second slice may comprise at least one of the following: an identity of the second slice, or crypto algorithm information specific to the second slice.

In an embodiment, the identity of the second slice may be the S-NSSAI value of the second slice. The crypto algorithm information specific to the second slice may for example relate to at least one of the following: an algorithm for UP integrity specific to the second slice, or an algorithm for UP encryption specific to the second slice.

The second slice may be equivalent to the first slice. For example, the second slice and the first slice may have the same or similar security level. By way of example, if a slice S-NSSAI #1 used by the UE 230 is not supported at the target access network device 110, the target access network device 110 may determine to use a second slice S-NSSAI #2 that is also supported by the source access network device 160 and the UE 230 so that temporary slice service continuity for the UE 230 may be achieved.

As an option, the network side may choose to perform the slice remapping with the awareness of the UE 230. For example, the target access network device 110 may decide to make the UE 230 be aware that the first slice has been remapped to the second slice. In this case, the target access network device 110 may transmit to the source access network device 160 the security information 416 specific to the second slice. For example, the security information 416 specific to the second slice may be transmitted via a handover request acknowledge 414. The handover request acknowledge 414 may indicate that the handover request is accepted and may include necessary information required for the UE 230 to perform the handover.

In this case, when the handover procedure is executed, the source access network device 160 may transmit to the UE 230 the security information 416 specific to the second slice, for the UE 230 to derive key(s) specific to the second slice. For example, in the operation 432, the UE 230 may use the security information 416 specific to the second slice as inputs to the KDF to derive second slice specific security key(s). For example, the UE 230 may derive the at least one security key specific to the second slice by inputting the identity of the second slice (e.g. S-NSSAI) and/or the crypto algorithm specific to the second slice into the KDF. Before, after or in parallel with the operation 432, in an operation 418, the target access network device 110 may use the security information 416 specific to the second slice as inputs to the KDF to derive second slice specific security key(s).

Various example embodiments of the present disclosure have been described above in connection with Xn based handover. It shall be appreciated that these embodiments are merely examples and are not intended to limit the scope of the present disclosure. In fact, the present disclosure may also be applicable to other mobility scenarios, e.g. where a UE may transition from a source RAN to a target RAN in an N2 based handover procedure.

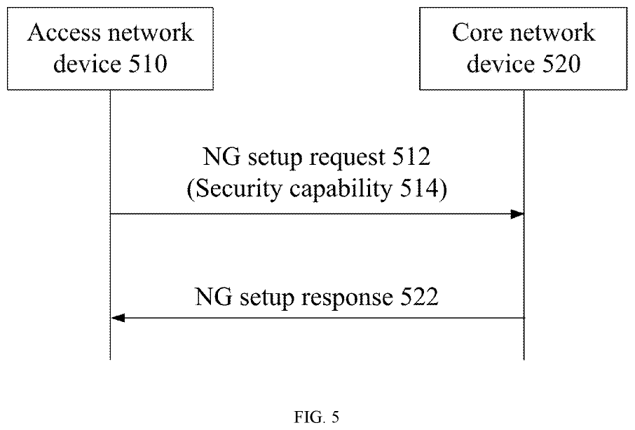

FIG. 5 shows an exemplary sequence diagram for exchange of slice specific security capability during NG setup according to an example embodiment of the present disclosure. Referring to the FIG. 5, an access network device 510 may function as a BTS, e.g. an eNB and/or a gNB in a wireless communication network. A core network device 520 may function as an AMF in the CN of the wireless communication network. In an example, the access network device 510 may perform e.g. an NG setup procedure of the 3rd Generation Partnership Project (3GPP) technical specification (TS) 38.413 with the core network device 520 to exchange application level data (e.g. the security capability) so as to facilitate the core network device 520 to select a target access network device in an N2 handover procedure.

In the NG setup procedure, the access network device 510 may transmit an NG setup request message 512 to the core network device 520. The NG setup request message 512 may include respective security capabilities 514 specific to one or more slices supported by the access network device 510. The respective security capabilities 514 may comprise at least one of the following: respective identities of the one or more slices supported by the access network device 510, or respective crypto algorithm specific to the one or more slices. For example, the identity of a slice may be a S-NSSAI value, and the crypto algorithm specific to a slice may relate to at least one of the following: an algorithm for UP integrity specific to the slice, or an algorithm for UP encryption specific to the slice. The respective security capabilities 514 may be in a form of a list of the S-NSSAI and corresponding crypto algorithm.

Then, the core network device 520 may transmit to the access network device 510 an NG setup response message 522 in response to the NG setup request message 512.

It may be appreciated that in the wireless communication network a plurality of access network devices may transmit to the core network device 520 respective security capabilities specific to one or more slices supported by the plurality of access network devices, respectively. The security capabilities of the respective plurality of access network devices may be used by the core network device 520 or another core network device to select an appropriate target access network device from the plurality of access network devices for a potential handover of a UE. Here, the access network device 510 may represent any of the plurality of access network devices.

Through the NG setup procedure, the core network device 520 may obtain the information on the security capabilities of the respective plurality of access network devices. It may be appreciated that the access network device 510 may transmit the respective security capabilities 514 specific to one or more slices supported by the access network device 510 via other message not limited to the NG setup request message 512 during the NG setup procedure.

In an example, when the core network device 520 has been aware of the security capabilities of the access network device 510 through the NG procedure, it may share this information to other core network devices (not shown). By the same token, the core network device 520 may receive the security capabilities of another access network device from the other core network devices.

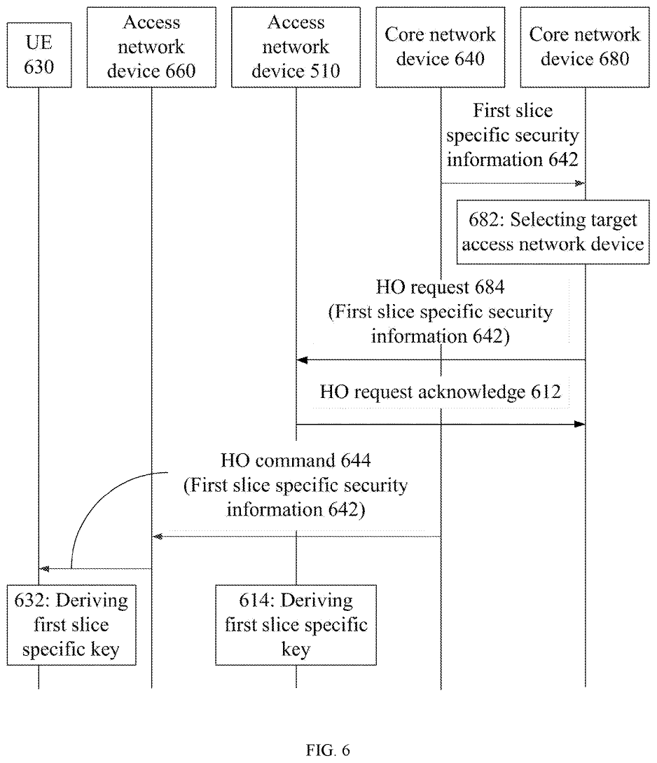

FIG. 6 shows an exemplary sequence diagram for slice specific key update during N2 based handover procedure according to example embodiments of the present disclosure. Referring to the FIG. 6, a UE 630 may represent any terminal device in the wireless communication network, which will perform a handover from an access network device 660 serving the UE 630. Thus the access network device 660 may be a source access network device for the handover. In addition, slice specific crypto algorithm may be negotiated between the UE 630 and a core network device 640 (e.g., an AMF) in the core network of the wireless communication network during a registration procedure. Thus the core network device 640 may be a source core network device associated with the handover.

When the source core network device 640 is unable to serve the UE 630, it may select a target core network device 680 for the handover and transmit the UE context information of the UE 630 to the target core network device 680. The UE context information may be conveyed via e.g. the Namf_Communication_CreateUEContext Request as defined in the 3GPP TS 23.502. Assuming that the UE 630 is currently using one or more slices, and the first slice may represent any of the one or more slices. The first slice is taken as an example in the descriptions, and it may be appreciated that the example embodiments of the present disclosure may apply in any of the one or more slices.

The source core network device 640 may transmit to the target core network device 680 security information 642 specific to the first slice. In an embodiment, the security information 642 specific to the first slice may be transmitted via the UE context information of the UE 630. In an embodiment, the security information 642 specific to the first slice may comprise e.g. at least one of the following: an identity of the first slice, or crypto algorithm information specific to the first slice.

In an embodiment, the identity of the first slice may be the S-NSSAI value of the first slice. The crypto algorithm information specific to the first slice may for example relate to at least one of the following: an algorithm for UP integrity specific to the first slice, or an algorithm for UP encryption specific to the first slice.

Then, in an operation 682, the target core access network device 680 may select the target access network device based on security capability of the target access network device specific to the first slice used by the UE 630. If the target core network device 680 is the core network device 520, the target core network device 680 may get the security capability of the target access network device, e.g. during the NG setup as discussed above with reference to FIG. 5. Alternatively, the core network device 520 may share the received security capability information with the target core network device 680.

For example, the target core network device 680 may select the target access network device that can support same or similar security capability specific to the first slice, from a plurality of access network devices. Assuming that among the plurality of access network devices, the access network device 510 is selected as the target access network device for the handover according to e.g. the security capability, of the access network device 510, specific to the first slice.

When the target access network device 510 is determined, the target core network device 680 may transmit to the target access network device 510, the security information 642 specific to the first slice used by the UE 630, so that the target access network device 510 may update security key(s) for the first slice. In an embodiment, the target core network device 680 may include the security information 642 in a handover request 684. In response to the handover request 684, the target access network device 510 may transmit a handover request acknowledge 612 to the target core network device 680.

When the handover procedure is executed, the source core network device 640 may transmit to the source access network device 660, e.g., via a handover command 644, the security information 642 specific to the first slice. Then the source access network device 660 may forward the security information 642 to the UE 630, so that the UE 630 and the target access network device 510 may synchronize to derive key(s) specific to the first slice.

In an embodiment, based on the security information 642 specific to the first slice received form the source core network device 640, the target access network device 510 and the UE 630 may derive the at least one security key specific to the first slice. For example, in an operation 614, the target access network device 510 may derive the security key by inputting the identity of the first slice (e.g. S-NSSAI) and/or the crypto algorithm specific to the first slice into a KDF. In an example, the crypto algorithm specific to the first slice may include one or more encryption and integrity algorithms for protection of UP data, respectively. One or more security keys specific to the first slice may be derived accordingly. On the UE side, in an operation 632, the UE 630 may derive at least one security key specific to the first slice in a similar manner. For example, the UE 630 may derive at least one security key specific to the first slice by inputting the security information 226 specific to the first slice into a KDF. With the derived security key(s) specific to the first slice, the UE 630 and the access network device 510 may protect uplink and downlink data.

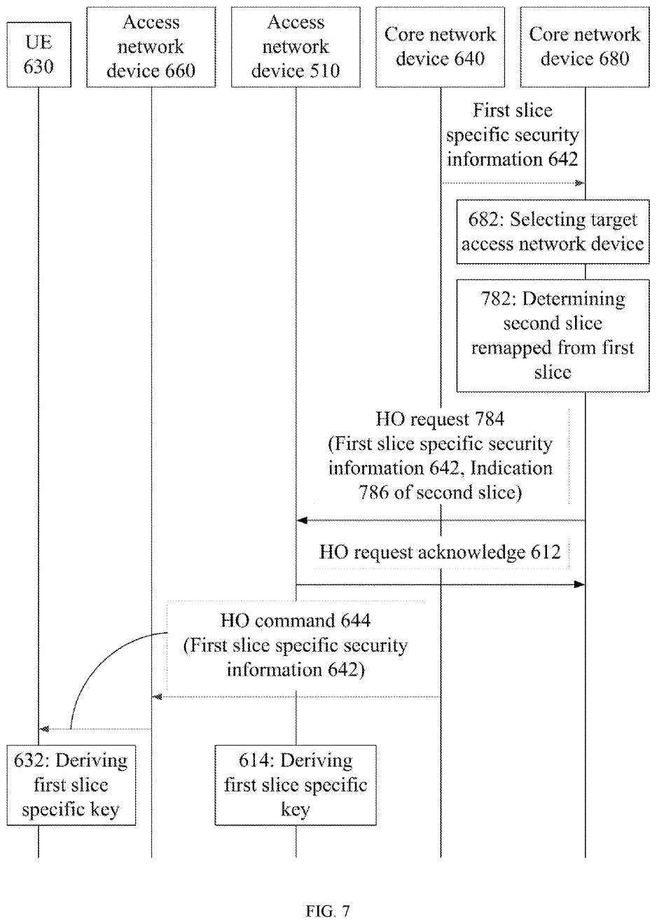

FIG. 7 shows an exemplary sequence diagram for slice specific key update during N2 based handover procedure according to example embodiments of the present disclosure. Some of the operations illustrated in FIG. 7 may be similar to some operations shown in, and described with respect to the previous figure(s). Thus, details which have been described with respect to the previous figure(s) are briefly described or omitted.

Referring to the FIG. 7, the source core network device 640 may transmit the security information 642 specific to the first slice to the target core network device 680. Then, in the operation 682, the target core network device 680 may select the target access network device 510 based on the security capability of the target access network device 510 specific to the first slice used by the UE 630.

In an embodiment, if the target core network device 680 knows that the first slice is unsupported by the target access network device 510, e.g., based on the security capability of the target access network device 510, or due to the first slice being overloaded in the target access network device 510, in an operation 782, the target core network device 680 may determine a second slice remapped from the first slice, so as to provide service continuity for the UE 630. The second slice may be equivalent to the first slice. For example, the second slice and the first slice may have the same or similar security level. By way of example, if a slice S-NSSAI #1 used by the UE 630 is not supported at the target access network device 510, the target core network device 680 may determine, for the target access network device 510, a second slice S-NSSAI #2 that is also supported by the source access network device 660 and the UE 630 so that temporary slice service continuity for the UE 630 may be achieved.

Since the target access network device 510 may provide the temporary service for the UE 630 by using the remapped second slice, the target core network device 680 may transmit a handover request 784 to the target access network device 510 to indicate that the handover of the UE 630. As an option, the network side may choose to perform the slice remapping without the awareness of the UE 630. For example, the target core network device 680 may decide not to make the UE 230 be aware that the first slice has been remapped to the second slice. This decision may be made considering capability of the UE 230, policy, etc. In this case, the target core network device 680 may still transmit security information 642 specific to the first slice used by the UE 630, e.g. via the handover request 784. In addition, the target core network device 680 may transmit to the target access network device 510, an indication 786 indicating that the second slice is remapped from the first slice, so that the target access network device 510 may use the remapped second slice to provide service continuity for the UE 630. The indication 786 may further indicate the target access network device 510 to use the security information 642 specific to the first slice to derive the security key(s) specific to the first slice. In response to the handover request 784, the target access network device 510 may transmit a handover request acknowledge 612 to the target core network device 680.

When the handover procedure is executed, the source core network device 640 may transmit to the source access network device 660, e.g., via a handover command 644, the security information 642 specific to the first slice, which may then be forwarded to the UE 630, for the UE 630 to derive key(s) specific to the first slice. For example, in the operation 632, the UE 630 may use the security information 642 specific to the first slice as inputs to the KDF to derive the first slice specific security key(s). For example, the UE 630 may derive at least one security key specific to the first slice by inputting the identity of the first slice (e.g. S-NSSAI) and/or the crypto algorithm specific to the first slice into the KDF. On the network side, the target access network device 510 may map the packet data unit (PDU) session associated with the UE 630 to the remapped second slice to allow service continuity. However, since the UE 230 is not aware of the slice remapping at the target access network device 510, for the sake of slice specific security, the target access network device 510 may, in the operation 614, continue to use the security information 642 specific to the first slice as inputs to the KDF to derive first slice specific security key(s).

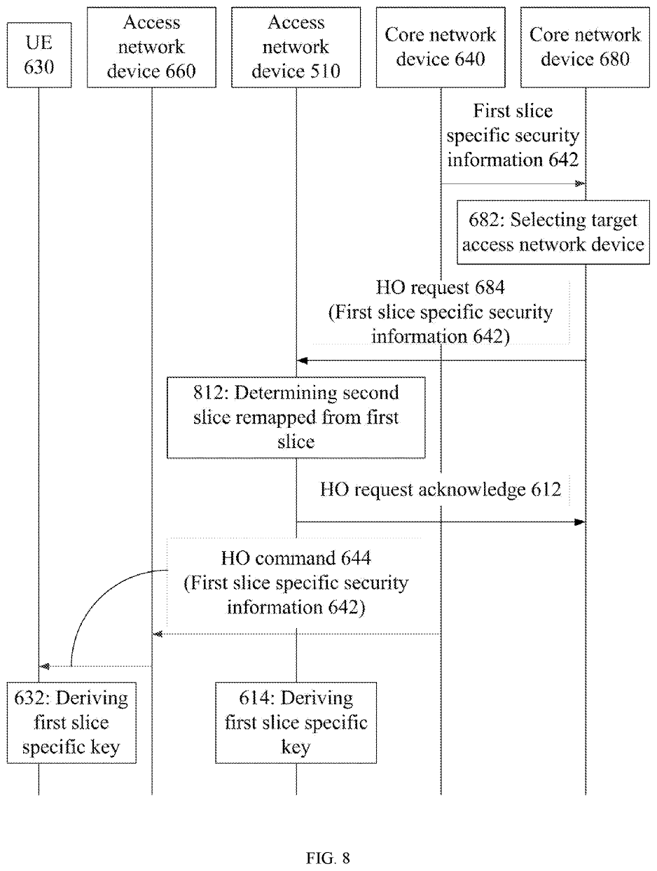

FIG. 8 shows an exemplary sequence diagram for slice specific key update during N2 based handover procedure according to example embodiments of the present disclosure. Some of the operations illustrated in the FIG. 8 may be similar to some operations shown in, and described with respect to the previous figure(s). Thus, details which have been described with respect to the previous figure(s) are briefly described or omitted.

Referring to the FIG. 8, the source core network device 640 may transmit the security information 642 specific to the first slice to the target core network device 680. Then, in the operation 682, the target core network device 680 may select the target access network device 510 based on the security capability of the target access network device 510 specific to a first slice used by the UE 630. Further, the target core network device 680 may transmit to the target access network device 510, the security information 642 specific to the first slice used by the UE 630, e.g. via the handover request 684.

In an embodiment, if the first slice is unsupported by the target access network device 510, in an operation 812, the target access network device 510 may determine a second slice remapped from the first slice, so as to provide service continuity for the UE 630. For example, the second slice may be equivalent to the first slice, e.g. having the same or similar security level to the first slice.

In an embodiment, the network side may choose to perform the slice remapping without the awareness of the UE 630. For example, the target access network device 510 may decide not to make the UE 230 be aware that the first slice has been remapped to the second slice. In this case, the handover request acknowledge 612 may be e.g. without security information specific to the second slice. Alternatively, for example, the target core network device 680 may decide not to make the UE 230 be aware of the slice remapping and indicate the target access network device 510 the same via e.g. the handover request 684, such that the target access network device 510 may not include the security information specific to the second slice in the handover request acknowledge 612 after the operation 812. This decision by the target access network device 510 or the target core network device 680 may be made considering capability of the UE 230, policy, etc., and in either case, as an option, the target access network device 510 may share the information of the slice remapping with the target core network device 680.

When the handover procedure is executed, the source core network device 640 may transmit to the source access network device 660, e.g., via the handover command 644, the security information 642 specific to the first slice, which may then be forwarded to the UE 630, for the UE 630 to derive key(s) specific to the first slice. For example, in the operation 632, the UE 630 may use the security information 642 specific to the first slice as inputs to the KDF to derive first slice specific security key(s). For example, the UE 630 may derive at least one security key specific to the first slice by inputting the identity of the first slice (e.g. S-NSSAI) and/or the crypto algorithm specific to the first slice into the KDF. Before, after or in parallel with the operation 632, in an operation 614, the target access network device 510 may also use the security information 642 specific to the first slice as inputs to the KDF to derive first slice specific security key(s).

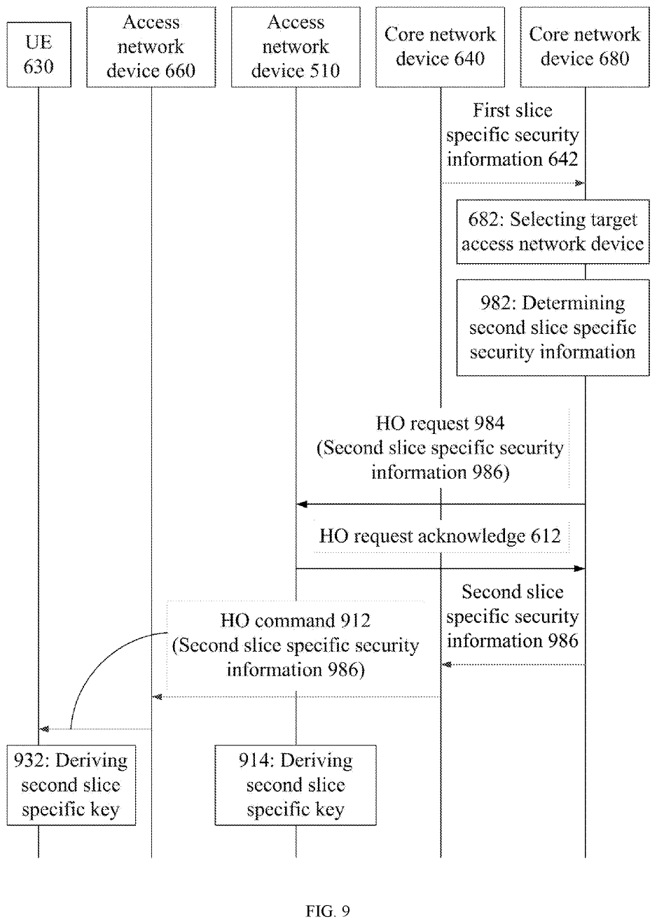

FIG. 9 shows an exemplary sequence diagram for slice specific key update during N2 based handover procedure according to example embodiments of the present disclosure. Some of the operations illustrated in FIG. 9 may be similar to some operations shown in, and described with respect to the previous figure(s). Thus, details which have been described with respect to the previous figure(s) are briefly described or omitted.

Referring to the FIG. 9, the source core network device 640 may transmit the security information 642 specific to the first slice to the target core network device 680. Then, in the operation 682, the target core network device 680 may select the target access network device 510 based on the security capability of the target access network device 510 specific to a first slice used by the UE 630.

In an embodiment, if the target core network device 680 knows that the first slice is unsupported by the target access network device 510, e.g., based on the security capability of the target access network device 510, or due to the first slice being overloaded in the target access network device 510, in an operation 982, the target core network device 680 may determine security information 986 specific to the second slice remapped from the first slice, so as to provide service continuity for the UE 630. The second slice may be equivalent to the first slice, and the security information 986 specific to the second slice may comprise at least one of the following: an identity of the second slice, or crypto algorithm information specific to the second slice.

In an embodiment, the identity of the second slice may be the S-NSSAI value of the second slice. The crypto algorithm information specific to the second slice may for example relate to at least one of the following: an algorithm for UP integrity specific to the second slice, or an algorithm for UP encryption specific to the second slice.

The second slice may be equivalent to the first slice. For example, the second slice and the first slice may have the same or similar security level. By way of example, if a slice S-NSSAI #1 used by the UE 630 is not supported at the target access network device 510, the target core network device 680 may determine, for the target access network device 510, a second slice S-NSSAI #2 that is also supported by the source access network device 660 and the UE 630 so that temporary slice service continuity for the UE 630 may be achieved.

As an option, the network side may choose to perform the slice remapping with the awareness of the UE 630. For example, the target core network device 680 may decide to make the UE 230 be aware of the slice remapping. This decision may be made considering capability of the UE 230, policy, etc. In this case, the target core network device 680 may transmit the security information 986 specific to the second slice to the target access network device 510 and the source core network device 640. For example, the security information 986 specific to the second slice may be transmitted to the target access network device 510 via a handover request 984, and may be transmitted to the core network device 640 via a Namf_Communication_CreateUEContext Response as defined in the 3GPP TS 23.502. In response to the handover request 984, the target access network device 510 may respond with a handover request acknowledge 612 which may indicate that the handover request is accepted and include necessary information required for the UE 630 to perform the handover.

In this case, when the handover procedure is executed, the source core network device 640 may transmit to the source access network device 660 the security information 986 specific to the second slice, e.g., via a handover command 912. Then the source access network device 660 may forward the security information 986 specific to the second slice to the UE 630, so that the UE 630 and the target access network device 510 may synchronize to derive key(s) specific to the second slice.

For example, in the operation 932, the UE 630 may use the security information 986 specific to the second slice as inputs to the KDF to derive the second slice specific security key(s). For example, the UE 630 may derive the at least one security key specific to the second slice by inputting the identity of the second slice (e.g. S-NSSAI) and/or the crypto algorithm specific to the second slice into the KDF. Before, after or in parallel with the operation 932, in an operation 914, the target access network device 510 may use the security information 986 specific to the second slice as inputs to the KDF to derive the second slice specific security key(s).

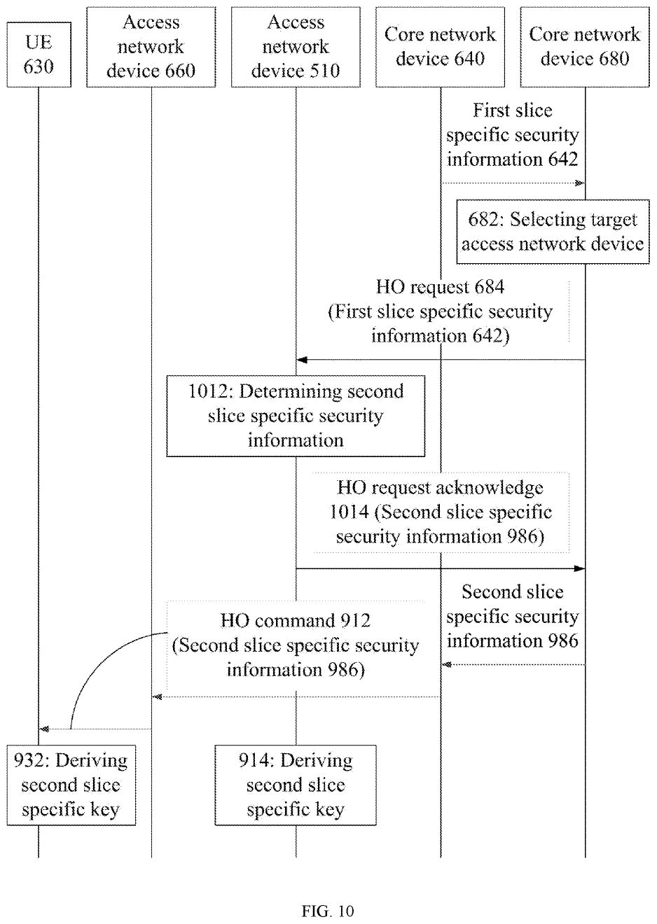

FIG. 10 shows an exemplary sequence diagram for slice specific key update during N2 based handover procedure according to example embodiments of the present disclosure. Some of the operations illustrated in FIG. 10 may be similar to some operations shown in, and described with respect to the previous figure(s). Thus, details which have been described with respect to the previous figure(s) are briefly described or omitted.

Referring to the FIG. 10, the source core network device 640 may transmit the security information 642 specific to the first slice to the target core network device 680. Then, in the operation 682, the target core network device 680 may select the target access network device 510 based on the security capability of the target access network device 510 specific to a first slice used by the UE 630. Further, the target core network device 680 may transmit to the target access network device 510, the security information 642 specific to the first slice used by the UE 630, e.g. via the handover request 684.

In an embodiment, if the first slice is unsupported by the target access network device 510, in an operation 1012, the target access network device 510 may determine security information 986 specific to the second slice remapped from the first slice, so as to provide service continuity for the UE 630. The second slice may be equivalent to the first slice, and the security information 986 specific to the second slice may comprise at least one of the following: an identity of the second slice, or crypto algorithm information specific to the second slice.

In an embodiment, the identity of the second slice may be the S-NSSAI value of the second slice. The crypto algorithm information specific to the second slice may for example relate to at least one of the following: an algorithm for UP integrity specific to the second slice, or an algorithm for UP encryption specific to the second slice.

The second slice may be equivalent to the first slice. For example, the second slice and the first slice may have the same or similar security level. By way of example, if a slice S-NSSAI #1 used by the UE 630 is not supported at the target access network device 510, the target access network device 510 may determine a second slice S-NSSAI #2 that is also supported by the source access network device 660 and the UE 630 so that temporary slice service continuity for the UE 630 may be achieved.

In an embodiment, the network side may choose to perform the slice remapping with the awareness of the UE 630. For example, the target access network device 510 may decide to make the UE 230 be aware that the first slice has been remapped to the second slice. In this case, the handover request acknowledge 1014 may include e.g. security information 986 specific to the second slice. Alternatively, for example, the target core network device 680 may decide to make the UE 230 be aware of the slice remapping and indicate the target access network device 510 the same via e.g. the handover request 684, such that the target access network device 510 may e.g. include the security information 986 specific to the second slice in the handover request acknowledge 1014 after the operation 1012. This decision by the target access network device 510 or the target core network device 680 may be made considering capability of the UE 230, policy, etc.

The target access network device 510 may transmit the security information 986 specific to the second slice to the target core network device 640, e.g. via a handover request acknowledge 1014. Then, the target core network device 640 may transmit this security information 986 specific to the second slice to the source core network device 640, e.g., via a Namf_Communication_CreateUEContext Response as defined in the 3GPP TS 23.502.

In this case, when the handover procedure is executed, the source core network device 640 may transmit to the source access network device 660 the security information 986 specific to the second slice, e.g., via a handover command 912. Then the source access network device 660 may forward the security information 986 specific to the second slice to the UE 630, so that the UE 630 can synchronize with the target access network device 510 to derive key(s) specific to the second slice.

For example, in the operation 932, the UE 630 may use the security information 986 specific to the second slice as inputs to the KDF to derive the second slice specific security key(s). For example, the UE 630 may derive the at least one security key specific to the second slice by inputting the identity of the second slice (e.g. S-NSSAI) and/or the crypto algorithm specific to the second slice into the KDF. Before, after or in parallel with the operation 932, in an operation 914, the target access network device 510 may use the security information 986 specific to the second slice as inputs to the KDF to derive second slice specific security key(s).

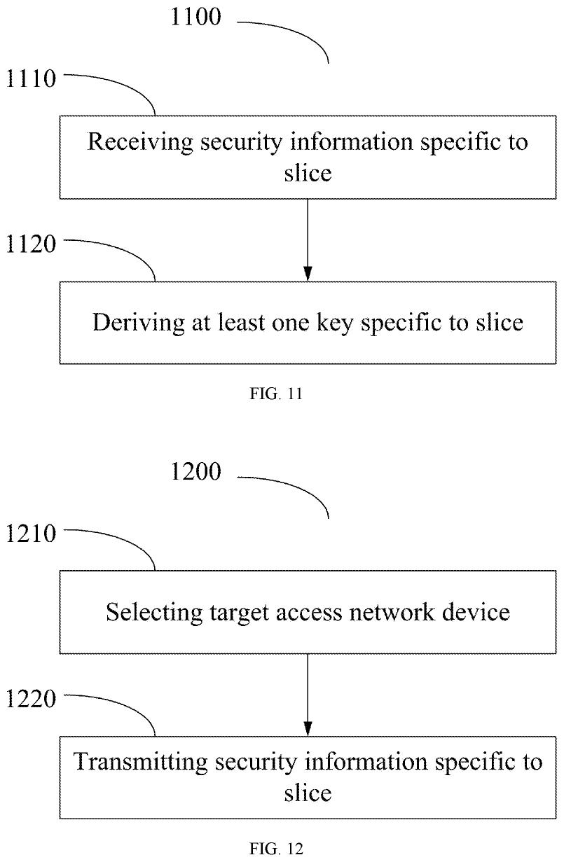

FIG. 11 shows a flow chart illustrating an example method 1100 for network slice security according to the example embodiments of the present disclosure. The example method 1100 may be performed for example by a terminal device such as the UE 230 and/or the UE 630.

Referring to the FIG. 11, the example method 1100 may include an operation 1110 of receiving from a source access network device associated with a handover of the terminal device, security information specific to a slice; and an operation 1120 of deriving at least one key specific to the slice based on the security information specific to the slice.

Details of the operation 1110 have been described in the above descriptions with respect to at least the security information 266 specific to the first slice, the security information 416 specific to the second slice, the security information 642 specific to the first slice and the security information 986 specific to the second slice, and repetitive descriptions thereof are omitted here.

Details of the operation 1120 have been described in the above descriptions with respect to at least the operation 232, the operation 432, the operation 632 and the operation 932, and repetitive descriptions thereof are omitted here.

In an embodiment, the slice may be a first slice or a second slice remapped from the first slice.

In an embodiment, the second slice may be equivalent to the first slice, the security information specific to the first slice may comprise at least one of the following: an identity of the first slice, or crypto algorithm information specific to the first slice, and the security information specific to the second slice may comprise at least one of the following: an identity of the second slice, or crypto algorithm information specific to the second slice. The more details have been described in the above descriptions with respect to at least the security information 266 specific to the first slice, the security information 416 specific to the second slice, the security information 642 specific to the first slice and the security information 986 specific to the second slice, and repetitive descriptions thereof are omitted here.

FIG. 12 shows a flow chart illustrating an example method 1200 for network slice security according to the example embodiments of the present disclosure. The example method 1200 may be performed for example by a network device such as the access network device 160, the access network device 660 and/or the core network device 680.

Referring to the FIG. 12, the example method 1200 may include an operation 1210 of selecting a target access network device associated with a handover of a terminal device, based on a security capability, of the target access network device, specific to a first slice used by the terminal device; and an operation 1220 of transmitting to the target access network device, security information specific to the first slice or security information specific to a second slice remapped from the first slice.

Details of the operation 1210 have been described in the above descriptions with respect to at least the operation 262 and the operation 682, and repetitive descriptions thereof are omitted here.

Details of the operation 1220 have been described in the above descriptions with respect to at least the security information 266 specific to the first slice and the security information 642 specific to the first slice, and repetitive descriptions thereof are omitted here.

In an embodiment, the security information specific to the first slice may comprise at least one of the following: an identity of the first slice, or crypto algorithm information specific to the first slice. The more details have been described in the above descriptions with respect to at least the security information 266 specific to the first slice and the security information 642 specific to the first slice, and repetitive descriptions thereof are omitted here.

In an embodiment, the network device may be a source access network device associated with the handover, and the example method 1200 may further include an operation of receiving from the target access network device, respective security capabilities specific to one or more slices supported by the target access network device. The more details have been described in the above descriptions with respect to at least the respective security capabilities 114 specific to one or more slices supported by the access network device 110, and repetitive descriptions thereof are omitted here.

In an embodiment, the respective security capabilities specific to the one or more slices may comprise at least one of the following: respective identities of the one or more slices or respective crypto algorithm information specific to the one or more slices. The more details have been described in the above descriptions with respect to at least the respective security capabilities 114 specific to one or more slices, and repetitive descriptions thereof are omitted here.

In an embodiment, the example method 1200 may further include an operation of receiving from the target access network device, security information specific to a second slice remapped from the first slice; and an operation of transmitting to the terminal device, the security information specific to the second slice. The more details have been described in the above descriptions with respect to at least the security information 416 specific to the second slice, and repetitive descriptions thereof are omitted here.

In an embodiment, the second slice may be equivalent to the first slice, and the security information specific to the second slice may comprise at least one of the following: an identity of the second slice, or crypto algorithm information specific to the second slice. The more details have been described in the above descriptions with respect to at least the security information 416 specific to the second slice, and repetitive descriptions thereof are omitted here.

In an embodiment, the network device may be a target core network device associated with the handover, and the example method 1200 may further include an operation of receiving from the target access network device or another core network device, respective security capabilities specific to one or more slices supported by the target access network device. The more details have been described in the above descriptions with respect to at least the respective security capabilities 514 specific to one or more slices, and repetitive descriptions thereof are omitted here.

In an embodiment, the respective security capabilities specific to the one or more slices may comprise at least one of the following: respective identities of the one or more slices or respective crypto algorithm information specific to the one or more slices. The more details have been described in the above descriptions with respect to at least the respective security capabilities 514 specific to one or more slices, and repetitive descriptions thereof are omitted here.

In an embodiment, the example method 1200 may further include an operation of receiving from a source core network device associated with the handover, the security information specific to the first slice. The more details have been described in the above descriptions with respect to at least the security information 642 specific to the first slice, and repetitive descriptions thereof are omitted here.

In an embodiment, the example method 1200 may further include an operation of determining a second slice remapped from the first slice in a case where the first slice is unsupported by the target access network device; and an operation of transmitting to the target access network device, an indication indicating that the second slice is remapped from the first slice. The more details have been described in the above descriptions with respect to at least the operation 782 and the indication 786, and repetitive descriptions thereof are omitted here.

In an embodiment, the example method 1200 may further include an operation of receiving from the target access network device, security information specific to a second slice remapped from the first slice; and an operation of transmitting to the source core network device, the security information specific to the second slice. The more details have been described in the above descriptions with respect to at least the security information 986 specific to the second slice, and repetitive descriptions thereof are omitted here.

In an embodiment, the example method 1200 may further include an operation of determining the security information specific to the second slice remapped from the first slice in a case where the first slice is unsupported by the target access network device; and an operation of transmitting to the source core network device, the security information specific to the second slice, the security information specific to the second slice may be transmitted to the target access network device. The more details have been described in the above descriptions with respect to at least the security information 986 specific to the second slice, and repetitive descriptions thereof are omitted here.

In an embodiment, the second slice may be equivalent to the first slice, and the security information specific to the second slice may comprise at least one of the following: an identity of the second slice, or crypto algorithm information specific to the second slice. The more details have been described in the above descriptions with respect to at least the security information 986 specific to the second slice, and repetitive descriptions thereof are omitted here.

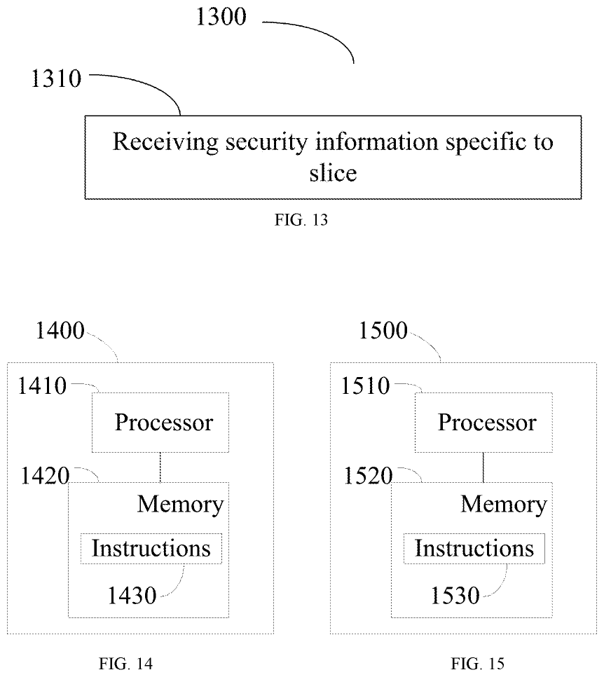

FIG. 13 shows a flow chart illustrating an example method 1300 for network slice security according to the example embodiments of the present disclosure. The example method 1300 may be performed for example by a network device as a target access network device associated with a handover of a terminal device, such as the access network device 110 and/or the access network device 510.

Referring to the FIG. 13, the example method 1300 may include an operation 1310 of receiving from another network device associated with the handover of the terminal device, security information specific to a first slice used by the terminal device or security information specific to a second slice remapped from the first slice.

Details of the operation 1310 have been described in the above descriptions with respect to at least the security information 266 specific to the first slice and the security information 642 specific to the first slice, and repetitive descriptions thereof are omitted here.

In an embodiment, the security information specific to the first slice comprises at least one of the following: an identity of the first slice, or crypto algorithm information specific to the first slice. The more details have been described in the above descriptions with respect to at least the security information 266 specific to the first slice and the security information 642 specific to the first slice, and repetitive descriptions thereof are omitted here.

In an embodiment, the example method 1300 may further include an operation of determining security information specific to a second slice remapped from the first slice in a case where the first slice is unsupported by the target access network device, and the second slice may be equivalent to the first slice, and the security information specific to the second slice may comprise at least one of the following: an identity of the second slice, or crypto algorithm information specific to the second slice. The more details have been described in the above descriptions with respect to at least the operation 412, the operation 1012, the security information 416 specific to the second slice and the security information 986 specific to the second slice, and repetitive descriptions thereof are omitted here.

In an embodiment, the example method 1300 may further include an operation of transmitting to the another network device, the security information specific to the second slice; and an operation of deriving at least one key specific to the second slice based on the security information specific to the second slice. The more details have been described in the above descriptions with respect to at least the security information 416 specific to the second slice, the security information 986 specific to the second slice, the operation 418 and the operation 914, and repetitive descriptions thereof are omitted here.

In an embodiment, the example method 1300 may further include an operation of determining a second slice remapped from the first slice in a case where the first slice is unsupported by the target access network device; and an operation of deriving at least one key specific to the first slice based on the security information specific to the first slice. The more details have been described in the above descriptions with respect to at least the operation 312, the operation 214, the operation 812 and the operation 614, and repetitive descriptions thereof are omitted here.

In an embodiment, the another network device may be a target core network device associated with the handover of the terminal device, and the example method 1300 may further include an operation of receiving from the target core network device, the security information specific to the second slice remapped from the first slice in a case where the first slice is unsupported by the target access network device; and an operation of deriving at least one key specific to the second slice based on the security information specific to the second slice, and the second slice may be equivalent to the first slice, and the security information specific to the second slice may comprise at least one of the following: an identity of the second slice, or crypto algorithm information specific to the second slice. The more details have been described in the above descriptions with respect to at least the security information 986 specific to the second slice and the operation 914, and repetitive descriptions thereof are omitted here.

In an embodiment, the another network device may be a target core network device associated with the handover of the terminal device, and the example method 1300 may further include an operation of receiving from the target core network device, an indication indicating that a second slice is remapped from the first slice; and an operation of deriving at least one key specific to the first slice based on the security information specific to the first slice. The more details have been described in the above descriptions with respect to at least the indication 786 and the operation 614, and repetitive descriptions thereof are omitted here.

In an embodiment, the another network device may be a target core network device associated with the handover of the terminal device, and the example method 1300 may further include an operation of deriving at least one key specific to the second slice based on the security information specific to the second slice in case of receiving from target core network device the security information specific to the second slice, the second slice may be equivalent to the first slice, and the security information specific to the second slice may comprise at least one of the following: an identity of the second slice, or crypto algorithm information specific to the second slice. The more details have been described in the above descriptions with respect to at least the security information 986 specific to the second slice and the operation 914, and repetitive descriptions thereof are omitted here.

In an embodiment, the another network device may be a source access network device associated with the handover of the terminal device, and the example method 1300 may further include an operation of transmitting to the source access network device, respective security capabilities specific to one or more slices supported by the target access network device. The more details have been described in the above descriptions with respect to at least the respective security capabilities 114 specific to one or more slices, and repetitive descriptions thereof are omitted here.

In an embodiment, the another network device may be a target core network device associated with the handover of the terminal device, and the example method 1300 may further include an operation of transmitting to the target core network device or another core network device, respective security capabilities specific to one or more slices supported by the target access network device. The more details have been described in the above descriptions with respect to at least the respective security capabilities 514 specific to one or more slices, and repetitive descriptions thereof are omitted here.

In an embodiment, the respective security capabilities specific to the one or more slices may comprise at least one of the following: respective identities of the one or more slices or respective crypto algorithm information specific to the one or more slices. The more details have been described in the above descriptions with respect to at least the respective security capabilities 114 specific to one or more slices and the respective security capabilities 514 specific to one or more slices, and repetitive descriptions thereof are omitted here.

FIG. 14 shows a block diagram illustrating an example device 1400 for network slice security according to the example embodiments of the present disclosure. The device, for example, may be at least part of a terminal device such as the UE 230 and/or the UE 630 in the above examples.

As shown in the FIG. 14, the example device 1400 may include at least one processor 1410 and at least one memory 1420 that may store instructions 1430. The instructions 1430, when executed by the at least one processor 1410, may cause the device 1400 at least to perform the example method 1100 described above.

In various example embodiments, the at least one processor 1410 in the example device 1400 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1410 may also include at least one other circuitry or element not shown in the FIG. 14.

In various example embodiments, the at least one memory 1420 in the example device 1400 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 1420 may include, but are not limited to, an electric, a magnetic, an optical, an electromagnetic, an infrared, or a semiconductor system, apparatus, or device or any combination of the above.

Further, in various example embodiments, the example device 1400 may also include at least one other circuitry, element, and interface, for example at least one I/O interface, at least one antenna element, and the like.

In various example embodiments, the circuitries, parts, elements, and interfaces in the example device 1400, including the at least one processor 1410 and the at least one memory 1420, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 230 and/or the UE 630 is not limited to the above example device 1400.

FIG. 15 shows a block diagram illustrating an example device 1500 for network slice security according to the example embodiments of the present disclosure. The device, for example, may be at least part of a network device such as the access network device 160, the access network device 660 and/or the core network device 680 in the above examples.

As shown in the FIG. 15, the example device 1500 may include at least one processor 1510 and at least one memory 1520 that may store instructions 1530. The instructions 1530, when executed by the at least one processor 1510, may cause the device 1500 at least to perform the example method 1200 described above.

In various example embodiments, the at least one processor 1510 in the example device 1500 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1510 may also include at least one other circuitry or element not shown in the FIG. 15.

In various example embodiments, the at least one memory 1520 in the example device 1500 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 1520 may include, but are not limited to, an electric, a magnetic, an optical, an electromagnetic, an infrared, or a semiconductor system, apparatus, or device or any combination of the above.

Further, in various example embodiments, the example device 1500 may also include at least one other circuitry, element, and interface, for example at least one I/O interface, at least one antenna element, and the like.

In various example embodiments, the circuitries, parts, elements, and interfaces in the example device 1500, including the at least one processor 1510 and the at least one memory 1520, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the access network device 160, the access network device 660 and/or the core network device 680 is not limited to the above example device 1500.

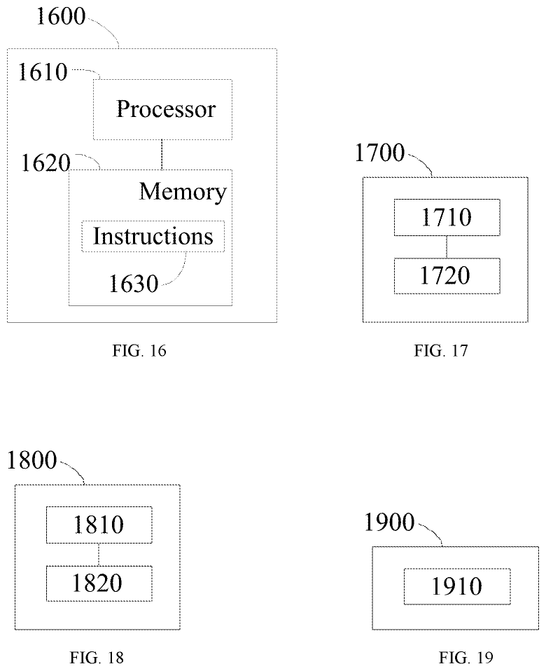

FIG. 16 shows a block diagram illustrating an example device 1600 for network slice security according to the example embodiments of the present disclosure. The device, for example, may be at least part of a network device as a target access network device associated with a handover of a terminal device, such as the access network device 110 and/or the access network device 510 in the above examples.

As shown in the FIG. 16, the example device 1600 may include at least one processor 1610 and at least one memory 1620 that may store instructions 1630. The instructions 1630, when executed by the at least one processor 1610, may cause the device 1600 at least to perform the example method 1300 described above.

In various example embodiments, the at least one processor 1610 in the example device 1600 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1610 may also include at least one other circuitry or element not shown in the FIG. 16.

In various example embodiments, the at least one memory 1620 in the example device 1600 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 1620 may include, but are not limited to, an electric, a magnetic, an optical, an electromagnetic, an infrared, or a semiconductor system, apparatus, or device or any combination of the above.

Further, in various example embodiments, the example device 1600 may also include at least one other circuitry, element, and interface, for example at least one I/O interface, at least one antenna element, and the like.

In various example embodiments, the circuitries, parts, elements, and interfaces in the example device 1600, including the at least one processor 1610 and the at least one memory 1620, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the access network device 110 and/or the access network device 510 is not limited to the above example device 1600.

FIG. 17 shows a block diagram illustrating an example apparatus 1700 for network slice security according to the example embodiments of the present disclosure. The apparatus, for example, may be at least part of a terminal device such as the UE 230 and/or the UE 630 in the above examples.

As shown in FIG. 17, the example apparatus 1700 may include means 1710 for performing the operation 1110 of the example method 1100, and means 1720 for performing the operation 1120 of the example method 1100. In one or more another example embodiments, at least one I/O interface, at least one antenna element, and the like may also be included in the example apparatus 1700.

In an embodiment, the slice may be a first slice or a second slice remapped from the first slice.

In an embodiment, the second slice may be equivalent to the first slice, the security information specific to the first slice may comprise at least one of the following: an identity of the first slice, or crypto algorithm information specific to the first slice, and the security information specific to the second slice may comprise at least one of the following: an identity of the second slice, or crypto algorithm information specific to the second slice.

In some example embodiments, examples of means in the example apparatus 1700 may include circuitries. For example, an example of means 1710 may include a circuitry configured to perform the operation 1110 of the example method 1100, and an example of means 1720 may include a circuitry configured to perform the operation 1120 of the example method 1100.

The example apparatus 1700 may further include means comprising circuitry configured to perform the example method 1100. In some example embodiments, examples of means may also include software modules and any other suitable function entities.

FIG. 18 shows a block diagram illustrating an example apparatus 1800 for network slice security according to the example embodiments of the present disclosure. The apparatus, for example, may be at least part of a network device such as the access network device 160, the access network device 660 and/or the core network device 680 in the above examples.

As shown in FIG. 18, the example apparatus 1800 may include means 1810 for performing the operation 1210 of the example method 1200, and means 1820 for performing the operation 1220 of the example method 1200. In one or more another example embodiments, at least one I/O interface, at least one antenna element, and the like may also be included in the example apparatus 1800.

In an embodiment, the security information specific to the first slice may comprise at least one of the following: an identity of the first slice, or crypto algorithm information specific to the first slice.

In an embodiment, the network device may be a source access network device associated with the handover, and the example apparatus 1800 may further include means for receiving from the target access network device, respective security capabilities specific to one or more slices supported by the target access network device.

In an embodiment, the respective security capabilities specific to the one or more slices may comprise at least one of the following: respective identities of the one or more slices or respective crypto algorithm information specific to the one or more slices.

In an embodiment, the example apparatus 1800 may further include means for receiving from the target access network device, security information specific to a second slice remapped from the first slice; and means for transmitting to the terminal device, the security information specific to the second slice.

In an embodiment, the second slice may be equivalent to the first slice, and the security information specific to the second slice may comprise at least one of the following: an identity of the second slice, or crypto algorithm information specific to the second slice.

In an embodiment, the network device may be a target core network device associated with the handover, and the example apparatus 1800 may further include means for receiving from the target access network device or another core network device, respective security capabilities specific to one or more slices supported by the target access network device.

In an embodiment, the respective security capabilities specific to the one or more slices may comprise at least one of the following: respective identities of the one or more slices or respective crypto algorithm information specific to the one or more slices.

In an embodiment, the example apparatus 1800 may further include means for receiving from a source core network device associated with the handover, the security information specific to the first slice.

In an embodiment, the example apparatus 1800 may further include means for determining a second slice remapped from the first slice in a case where the first slice is unsupported by the target access network device; and means for transmitting to the target access network device, an indication indicating that the second slice is remapped from the first slice.

In an embodiment, the example apparatus 1800 may further include means for receiving from the target access network device, security information specific to a second slice remapped from the first slice; and means for transmitting to the source core network device, the security information specific to the second slice.

In an embodiment, the example apparatus 1800 may further include means for determining the security information specific to the second slice remapped from the first slice in a case where the first slice is unsupported by the target access network device; and means for transmitting to the source core network device, the security information specific to the second slice, and the security information specific to the second slice may be transmitted to the target access network device.

In an embodiment, the second slice may be equivalent to the first slice, and the security information specific to the second slice may comprise at least one of the following: an identity of the second slice, or crypto algorithm information specific to the second slice. In some example embodiments, examples of means in the example apparatus 1800 may include circuitries. For example, an example of means 1810 may include a circuitry configured to perform the operation 1210 of the example method 1200, and an example of means 1820 may include a circuitry configured to perform the operation 1220 of the example method 1200.

The example apparatus 1800 may further include means comprising circuitry configured to perform the example method 1200. In some example embodiments, examples of means may also include software modules and any other suitable function entities.

FIG. 19 shows a block diagram illustrating an example apparatus 1900 for network slice security according to the example embodiments of the present disclosure. The apparatus, for example, may be at least part of an access network device as a target access network device associated with a handover of a terminal device, such as the access network device 110 and/or the access network device 510 in the above examples.

As shown in FIG. 19, the example apparatus 1900 may include means 1910 for performing the operation 1310 of the example method 1300. In one or more another example embodiments, at least one I/O interface, at least one antenna element, and the like may also be included in the example apparatus 1900.

In an embodiment, the security information specific to the first slice comprises at least one of the following: an identity of the first slice, or crypto algorithm information specific to the first slice.

In an embodiment, the example apparatus 1900 may further include means for determining security information specific to a second slice remapped from the first slice in a case where the first slice is unsupported by the target access network device, and the second slice may be equivalent to the first slice, and the security information specific to the second slice may comprise at least one of the following: an identity of the second slice, or crypto algorithm information specific to the second slice.

In an embodiment, the example apparatus 1900 may further include means for transmitting to the another network device, the security information specific to the second slice; and means for deriving at least one key specific to the second slice based on the security information specific to the second slice.

In an embodiment, the example apparatus 1900 may further include means for determining a second slice remapped from the first slice in a case where the first slice is unsupported by the target access network device; and means for deriving at least one key specific to the first slice based on the security information specific to the first slice.

In an embodiment, the another network device may be a target core network device associated with the handover of the terminal device, and the example apparatus 1900 may further include means for receiving from the target core network device, the security information specific to the second slice remapped from the first slice in a case where the first slice is unsupported by the target access network device; and means for deriving at least one key specific to the second slice based on the security information specific to the second slice, and the second slice may be equivalent to the first slice, and the security information specific to the second slice may comprise at least one of the following: an identity of the second slice, or crypto algorithm information specific to the second slice.

In an embodiment, the another network device may be a target core network device associated with the handover of the terminal device, and the example apparatus 1900 may further include means for receiving from the target core network device, an indication indicating that a second slice is remapped from the first slice; and means for deriving at least one key specific to the first slice based on the security information specific to the first slice.

In an embodiment, the another network device may be a target core network device associated with the handover of the terminal device, and the example apparatus 1900 may further include means for deriving at least one key specific to the second slice based on the security information specific to the second slice in case of receiving from target core network device the security information specific to the second slice, the second slice may be equivalent to the first slice, and the security information specific to the second slice may comprise at least one of the following: an identity of the second slice, crypto algorithm information specific to the second slice.

In an embodiment, the another network device may be a source access network device associated with the handover of the terminal device, and the example apparatus 1900 may further include means for transmitting to the source access network device, respective security capabilities specific to one or more slices supported by the target access network device. In an embodiment, the another network device may be a target core network device associated with the handover of the terminal device, and the example apparatus 1900 may further include means for transmitting to the target core network device or another core network device, respective security capabilities specific to one or more slices supported by the target access network device.

In an embodiment, the respective security capabilities specific to the one or more slices may comprise at least one of the following: respective identities of the one or more slices or respective crypto algorithm information specific to the one or more slices.

The example embodiments of the present disclosure also provide a computer readable medium comprising program instructions that, when executed by a terminal device such as the UE 230 and/or the UE 630 in the above examples, may cause the terminal device at least to perform: receiving from a source access network device associated with a handover of the terminal device, security information specific to a slice; and deriving at least one key specific to the slice based on the security information specific to the slice.

In an embodiment, the slice may be a first slice or a second slice remapped from the first slice.

In an embodiment, the second slice may be equivalent to the first slice, the security information specific to the first slice may comprise at least one of the following: an identity of the first slice, or crypto algorithm information specific to the first slice, and the security information specific to the second slice may comprise at least one of the following: an identity of the second slice, or crypto algorithm information specific to the second slice.

The example embodiments of the present disclosure also provide a computer readable medium comprising program instructions that, when executed by a network device such as the access network device 160, the access network device 660 and/or the core network device 680 in the above examples, may cause the network device at least to perform: selecting a target access network device associated with a handover of a terminal device, based on a security capability, of the target access network device, specific to a first slice used by the terminal device; and transmitting to the target access network device, security information specific to the first slice or security information specific to a second slice remapped from the first slice.

In an embodiment, the security information specific to the first slice may comprise at least one of the following: an identity of the first slice, or crypto algorithm information specific to the first slice.

In an embodiment, the network device may be a source access network device associated with the handover, and the computer readable medium may further include instructions that, when executed by the network device, may cause the network device to further perform: receiving from the target access network device, respective security capabilities specific to one or more slices supported by the target access network device.

In an embodiment, the respective security capabilities specific to the one or more slices may comprise at least one of the following: respective identities of the one or more slices or respective crypto algorithm information specific to the one or more slices.

In an embodiment, the computer readable medium may further include instructions that, when executed by the network device, may cause the network device to further perform: receiving from the target access network device, security information specific to a second slice remapped from the first slice; and transmitting to the terminal device, the security information specific to the second slice.

In an embodiment, the second slice may be equivalent to the first slice, and the security information specific to the second slice may comprise at least one of the following: an identity of the second slice, or crypto algorithm information specific to the second slice.

In an embodiment, the network device may be a target core network device associated with the handover, and the computer readable medium may further include instructions that, when executed by the network device, may cause the network device to further perform: receiving from the target access network device or another core network device, respective security capabilities specific to one or more slices supported by the target access network device.

In an embodiment, the respective security capabilities specific to the one or more slices may comprise at least one of the following: respective identities of the one or more slices or respective crypto algorithm information specific to the one or more slices.

In an embodiment, the computer readable medium may further include instructions that, when executed by the network device, may cause the network device to further perform: receiving from a source core network device associated with the handover, the security information specific to the first slice.

In an embodiment, the computer readable medium may further include instructions that, when executed by the network device, may cause the network device to further perform: determining a second slice remapped from the first slice in a case where the first slice is unsupported by the target access network device; and transmitting to the target access network device, an indication indicating that the second slice is remapped from the first slice.

In an embodiment, the computer readable medium may further include instructions that, when executed by the network device, may cause the network device to further perform: receiving from the target access network device, security information specific to a second slice remapped from the first slice; and transmitting to the source core network device, the security information specific to the second slice.

In an embodiment, the computer readable medium may further include instructions that, when executed by the network device, may cause the network device to further perform: determining the security information specific to the second slice remapped from the first slice in a case where the first slice is unsupported by the target access network device; and transmitting to the source core network device, the security information specific to the second slice, and the security information specific to the second slice may be transmitted to the target access network device.

In an embodiment, the second slice may be equivalent to the first slice, and the security information specific to the second slice may comprise at least one of the following: an identity of the second slice, or crypto algorithm information specific to the second slice.

The example embodiments of the present disclosure also provide a computer readable medium comprising program instructions that, when executed by an access network device as a target access network device associated with a handover of a terminal device, such as the access network device 110 and/or the access network device 510 in the above examples, may cause the access network device at least to perform: receiving from another network device associated with the handover of the terminal device, security information specific to a first slice used by the terminal device or security information specific to a second slice remapped from the first slice.

In an embodiment, the security information specific to the first slice comprises at least one of the following: an identity of the first slice, or crypto algorithm information specific to the first slice.

In an embodiment, the computer readable medium may further include instructions that, when executed by the access network device, may cause the access network device to further perform: determining security information specific to a second slice remapped from the first slice in a case where the first slice is unsupported by the target access network device, and the second slice may be equivalent to the first slice, and the security information specific to the second slice may comprise at least one of the following: an identity of the second slice, or crypto algorithm information specific to the second slice.

In an embodiment, the computer readable medium may further include instructions that, when executed by the access network device, may cause the access network device to further perform: transmitting to the another network device, the security information specific to the second slice; and deriving at least one key specific to the second slice based on the security information specific to the second slice.

In an embodiment, the computer readable medium may further include instructions that, when executed by the access network device, may cause the access network device to further perform: determining a second slice remapped from the first slice in a case where the first slice is unsupported by the target access network device; and deriving at least one key specific to the first slice based on the security information specific to the first slice.

In an embodiment, the another network device may be a target core network device associated with the handover of the terminal device, and the computer readable medium may further include instructions that, when executed by the access network device, may cause the access network device to further perform: receiving from the target core network device, the security information specific to the second slice remapped from the first slice in a case where the first slice is unsupported by the target access network device; and deriving at least one key specific to the second slice based on the security information specific to the second slice, and the second slice may be equivalent to the first slice, and the security information specific to the second slice may comprise at least one of the following: an identity of the second slice, or crypto algorithm information specific to the second slice.

In an embodiment, the another network device may be a target core network device associated with the handover of the terminal device, and the computer readable medium may further include instructions that, when executed by the access network device, may cause the access network device to further perform: receiving from the target core network device, an indication indicating that a second slice is remapped from the first slice; and deriving at least one key specific to the first slice based on the security information specific to the first slice.

In an embodiment, the another network device may be a target core network device associated with the handover of the terminal device, and the computer readable medium may further include instructions that, when executed by the access network device, may cause the access network device to further perform: deriving at least one key specific to the second slice based on the security information specific to the second slice in case of receiving from target core network device the security information specific to the second slice, the second slice may be equivalent to the first slice, and the security information specific to the second slice may comprise at least one of the following: an identity of the second slice, or crypto algorithm information specific to the second slice.

In an embodiment, the another network device may be a source access network device associated with the handover of the terminal device, and the computer readable medium may further include instructions that, when executed by the access network device, may cause the access network device to further perform: transmitting to the source access network device, respective security capabilities specific to one or more slices supported by the target access network device.

In an embodiment, the another network device may be a target core network device associated with the handover of the terminal device, and the computer readable medium may further include instructions that, when executed by the access network device, may cause the access network device to further perform: transmitting to the target core network device or another core network device, respective security capabilities specific to one or more slices supported by the target access network device.

In an embodiment, the respective security capabilities specific to the one or more slices may comprise at least one of the following: respective identities of the one or more slices or respective crypto algorithm information specific to the one or more slices.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the above description, the terms “terminal device”, “communication device”, “terminal”, “user equipment” and “UE” may be used interchangeably.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
3GPP 3rd Generation Partnership Project
5GS fifth generation system
AMF access and mobility management function
BTS base transceiver station
CN core network
CU centralized unit
eNB evolved node-B
gNB next generation node-B
HO handover
KDF key derivation function
PDU protocol data unit
RAN radio access network
RRC radio resource control
RRM radio resource management
S-NSSAI single network slice selection assistance information
TS technical specification
UE user equipment
UP user plane

1-64. (canceled)

65. A terminal device, comprising:
at least one processor; and
at least one memory storing instructions that, when executed by the at least one processor, cause the terminal device at least to perform:
receiving from a source access network device associated with a handover of the terminal device, security information specific to a slice; and
deriving at least one key specific to the slice based on the security information specific to the slice.

66. The terminal device of claim 65, wherein the slice is a first slice or a second slice remapped from the first slice.

67. The terminal device of claim 66, wherein the second slice is equivalent to the first slice, the security information specific to the first slice comprises at least one of the following: an identity of the first slice, or crypto algorithm information specific to the first slice, and the security information specific to the second slice comprises at least one of the following: an identity of the second slice, or crypto algorithm information specific to the second slice.

68. A network device, comprising:
at least one processor; and
at least one memory storing instructions that, when executed by the at least one processor, cause the network device at least to perform:
selecting a target access network device associated with a handover of a terminal device, based on a security capability, of the target access network device, specific to a first slice used by the terminal device; and
transmitting to the target access network device, security information specific to the first slice or security information specific to a second slice remapped from the first slice.

69. The network device of claim 68, wherein the security information specific to the first slice comprises at least one of the following: an identity of the first slice, or crypto algorithm information specific to the first slice.

70. The network device of claim 68, wherein the network device is a source access network device associated with the handover, and the instructions, when executed by the at least one processor, cause the network device to further perform:
receiving from the target access network device, respective security capabilities specific to one or more slices supported by the target access network device.

71. The network device of claim 70, wherein the respective security capabilities specific to the one or more slices comprise at least one of the following: respective identities of the one or more slices or respective crypto algorithm information specific to the one or more slices.

72. The network device of claim 70, wherein the instructions, when executed by the at least one processor, cause the network device to further perform:
receiving from the target access network device, security information specific to a second slice remapped from the first slice; and
transmitting to the terminal device, the security information specific to the second slice.

73. The network device of claim 72, wherein the second slice is equivalent to the first slice, and the security information specific to the second slice comprises at least one of the following: an identity of the second slice, or crypto algorithm information specific to the second slice.

74. The network device of claim 68, wherein the network device is a target core network device associated with the handover, and the instructions, when executed by the at least one processor, cause the network device to further perform:
receiving from the target access network device or another core network device, respective security capabilities specific to one or more slices supported by the target access network device.

75. The network device of claim 74, wherein the respective security capabilities specific to the one or more slices comprise at least one of the following: respective identities of the one or more slices or respective crypto algorithm information specific to the one or more slices.

76. The network device of claim 74, wherein the instructions, when executed by the at least one processor, cause the network device to further perform:
receiving from a source core network device associated with the handover, the security information specific to the first slice.

77. The network device of claim 74, wherein the instructions, when executed by the at least one processor, cause the network device to further perform:
determining a second slice remapped from the first slice in a case where the first slice is unsupported by the target access network device; and
transmitting to the target access network device, an indication indicating that the second slice is remapped from the first slice.

78. The network device of claim 76, wherein the instructions, when executed by the at least one processor, cause the network device to further perform:
receiving from the target access network device, security information specific to a second slice remapped from the first slice; and
transmitting to the source core network device, the security information specific to the second slice.

79. The network device of claim 76, wherein the instructions, when executed by the at least one processor, cause the network device to further perform:
determining the security information specific to the second slice remapped from the first slice in a case where the first slice is unsupported by the target access network device; and
transmitting to the source core network device, the security information specific to the second slice,
the security information specific to the second slice being transmitted to the target access network device.

80. The network device of claim 77, wherein the second slice is equivalent to the first slice, and the security information specific to the second slice comprises at least one of the following: an identity of the second slice, or crypto algorithm information specific to the second slice.

81. An access network device, comprising:
at least one processor; and
at least one memory storing instructions that, when executed by the at least one processor, cause the access network device as a target access network device associated with a handover of a terminal device at least to perform:
receiving from another network device associated with the handover of the terminal device, security information specific to a first slice used by the terminal device or security information specific to a second slice remapped from the first slice.

82. The access network device of claim 81, wherein the security information specific to the first slice comprises at least one of the following: an identity of the first slice, or crypto algorithm information specific to the first slice.

83. The access network device of claim 81, wherein the instructions, when executed by the at least one processor, cause the access network device to further perform:
determining security information specific to a second slice remapped from the first slice in a case where the first slice is unsupported by the target access network device,
the second slice being equivalent to the first slice, and the security information specific to the second slice comprising at least one of the following: an identity of the second slice, or crypto algorithm information specific to the second slice.

84. The access network device of claim 83, wherein the instructions, when executed by the at least one processor, cause the access network device to further perform:
transmitting to the another network device, the security information specific to the second slice; and
deriving at least one key specific to the second slice based on the security information specific to the second slice.
